(19) United States
(12) Patent Application Publication
(10) Pub. No.: US 2012/0305484 A1
(43) Pub. Date: Dec. 6, 2012

(54) Thermally Rearranged (TR) Polymers as Membranes for Ethanol Dehydration

(75) Inventors: Benny D. Freeman, Austin, TX (US); Donald R. Paul, Austin, TX (US); Katrina Czenkusch, Round Rock, TX (US); Claudio P. Ribeiro, JR., Austin, TX (US); Chaoyi Ba, Austin, TX (US)

(73) Assignee: Board of Regents, The University of Texas System, Austin, TX (US)

(21) Appl. No.: 13/153,085

(22) Filed: Jun. 3, 2011

(51) Int. Cl. B01D 71/62; B01D 61/36; B01D 63/00; B01D 71/66

(52) U.S. Cl. 210/640; 210/500.33; 210/321.63; 210/321.6; 210/179

(57) ABSTRACT

Synthesis and use of a new class of polymeric materials with favorable separation characteristics for the dehydration of ethanol and other organic solvents is described herein. The thermally rearranged (TR) polybenzoxazole (PBO), polybenzimidazole (PBI) and polybenzothiazole (PBT) membranes of the present invention can be used for the dehydration of ethanol during processing to fuel grade biodiesel by either pervaporation or vapor permeation. The unique microstructure of the membranes provides excellent separation characteristics, and this, coupled with their inherent thermal and chemical stability, enables their usage in other separations, such as the dehydration of other organic solvents.

### CROSS-REFERENCE TO RELATED APPLICATIONS

None.

### TECHNICAL FIELD OF THE INVENTION

The present invention relates in general to the field of membrane based separations and, more particularly, to the synthesis and use of a new class of polymeric membranes for ethanol dehydration.

### STATEMENT OF FEDERALLY FUNDED RESEARCH

None.

### REFERENCE OF A SEQUENCE LISTING

None.

### BACKGROUND OF THE INVENTION

The present invention pertains to high performance thermally rearranged aromatic polyimides and aromatic polyamides with high chemical and thermal stability for use as ethanol dehydration membranes.

The fuel-grade ethanol market is expected to double within the next 10 years (1). Current bioethanol fermentation results in 3-15 wt % ethanol in water that must be purified to more than 99 wt % to be used as fuel (2)(3). The dehydration cannot be done by simple distillation because of the azeotrope at approximately 96 wt % ethanol (4). The current industrial standard for this separation begins with concentrating the dilute ethanol feed to approximately 50 wt % via energy-intensive distillation in a so-called beer still. The ethanol is then concentrated to about 93 wt % in a second distillation column. The final product is produced using molecular sieves that concentrate the ethanol through the azeotrope to more than 99 wt % ethanol (5). This industrial separation process has a large physical footprint and energy costs that can exceed the ethanol heating value, depending on the feed stream ethanol content (2).

Polymeric membranes are an attractive alternative to the conventional technology described above. Membrane-based processes typically offer greater flexibility, reduced energy requirements, easier process integration, lower capital and operating costs, and a smaller footprint relative to traditional separation processes (6). In the ethanol-water separation, both the molecular sieves and the second distillation column have been identified as key energy-intensive components that could be replaced by membrane technology. Simulations have shown that with proper energy integration, a distillation-membrane hybrid process could require less than half the total energy of a conventional distillation-molecular sieve process (7).

Plasticization and chemical degradation are key challenges preventing widespread commercial use of membranes for ethanol dehydration. Plasticization occurs when a highly sorbing penetrant causes the polymer to swell and increases chain mobility. The increase in chain mobility causes an increase in penetrant flux and a drastic reduction in selectivity. Glassy polymers are particularly sensitive to plasticization because they separate based on size induced mobility differences due to the rigidness of the polymer chains. Membranes used for azeotropic ethanol-water separations, such as poly(vinyl alcohol) (PVA) and cross-linked cellulose esters, cannot be used for higher water concentrations beyond a few percent, due to extensive plasticization (3)(8).

Another key challenge for membranes is achieving sufficient chemical stability at the conditions envisioned for this separation, including temperatures higher than 100° C., pressures of several bar, and feeds of varying composition (2). These high temperature and pressure conditions increase the driving force for transport, causing an increase in the flux across the membrane. The higher temperatures also increase the efficiency of the energy recovery process. Many polymer membranes, particularly polyimide membranes, are subject to hydrolysis under these conditions. Thus a commercial membrane requires adequate transport properties, a high chemical stability, and plasticization resistance. Current commercial membranes have not successfully met all of these requirements.

One embodiment of the present invention includes aromatic polymers interconnected with heterocyclic rings, such as polybenzoxazole (PBO), polyimidazoles (PBI) and polybenzothiazoles (PBT), which have a rigid-rod structure with high-torsional energy barriers to rotation between two individual phenylene-heterocyclic rings (9). These features yield very stiff polymer chains that could lead to high selectivities that arise from penetrant size-induced mobility differences. However, due to their high chemical resistance, they do not dissolve in common solvents. Since commercial membranes are produced by solvent casting, traditional PBO, PBI, and PBT synthesis techniques cannot be used to easily produce thin, high flux membranes. This challenge was recently overcome by Park et al. (10), who adopted a post-fabrication, solid-state thermal treatment that converts initially soluble aromatic polyimides containing ortho-positioned functional groups (e.g. —OH, —NH₂ and —SH) into polybenzoxazoles, polybenzimidazoles and polybenzothiazoles, as illustrated in FIG. 1. Aromatic polyamide structures with ortho-positioned functional groups have also been shown to undergo a dehydration reaction to form similar PBO, PBI or PBT structures, FIG. 2 (11).

Dense membranes prepared from these thermally rearranged (TR) aromatic polyimides or aromatic polyamides have shown excellent CO₂/CH₄ separation characteristics (10) with both high selectivity and permeability due to an unusual microstructure, high free volume and rigid chains. These TR polymers also exhibit extremely high plasticization resistance in mixed gas studies, which is expected because of the insolubility of the PBO/PBI/PBT structure. The TR materials' transport properties are between those of typical polymers and those of carbon molecular sieves. The TR materials are tough, ductile and robust, unlike carbon molecular sieves, which are brittle, fragile materials.

These gas separation results are promising for energy efficient ethanol dehydration. The size-sieving microstructure of the TR polymers should allow a high water transport rate while retaining the ethanol on the feed side of the membrane. Furthermore, the PBO, PBI or PBT chemical resistance is confirmed by the high CO₂ plasticization resistance, which may translate to a high water and ethanol plasticization resistance. Finally the PBO, PBI, and PBT structures are expected to have a high resistance to hydrolysis even at elevated temperatures and pressures. However, there are no known reports that describe using these TR materials for ethanol dehydration.

WIPO Patent Application No. WO/2009/107889 (Lee et al., 2009) discloses a polyimide-polybenzoxazole copolymer, a method for the preparation thereof, and a gas separation membrane comprising the same. More specifically, provided are a polyimide-polybenzoxazole copolymer simply prepared through thermal-rearrangement; the process involves thermally treating a polyimide-poly(hydroxyimide) copolymer as a precursor, a method for preparing the same, and a gas separation membrane comprising the same. The copolymer shows superior gas permeability and gas selectivity, making it suitable for use in gas separation membranes in such forms as films, fibers or hollow fibers. Due to the high stability of the polymer backbone, the gas separation membrane thus prepared can advantageously endure even harsh conditions, such as long operation time, acidic conditions, and high humidity. However, the polyimide structures in the backbone of these copolymers provide a potential hydrolysis site that will reduce the long-term stability of these membranes in the feeds envisioned for the ethanol dehydration. Furthermore, no effort has been made to optimize the polymers for an ethanol/water separation. Ethanol/water membranes have very different separation and process requirements from the gas separation membrane systems. The membranes described herein have been tailored to meet the specific ethanol/water separation issues.

U.S. Patent Application No. 20100133186 (Liu et al., 2010) relates to high performance cross-linked polybenzoxazole and polybenzothiazole polymer membranes and methods for making and using these membranes. The cross-linked polybenzoxazole and polybenzothiazole polymer membranes are prepared by synthesizing polyimide polymers comprising ortho-positioned functional groups (e.g., —OH or —SH) and cross-linkable functional groups. The polyimide membranes are then fabricated into the desired geometry, and the membranes undergo a thermal rearrangement to a polybenzoxazole-co-imide or polybenzothiazole-co-imide structure. Finally, the membranes are converted to the final structure via a crosslinking treatment such as UV radiation. The high performance cross-linked polybenzoxazole and polybenzothiazole polymer membranes of Liu et al. may be suitable for a variety of liquid, gas, and vapor separations. However, the membranes described herein achieve their high performance without the additional crosslinking step, which reduces membrane production costs, allowing these membranes to compete more favorably with the dominate distillation technology. Furthermore, the membranes described in this patent have properties tuned specifically for ethanol dehydration, rather than generic separation membranes.

In U.S. Pat. No. 7,810,652 issued to Liu et al. (2010) discloses a method to improve the gas, vapor, and liquid separation selectivities of polybenzoxazole (PBO) membranes prepared from aromatic polyimide membranes. The PBO membranes of the '652 patent are prepared by thermal treatment of an aromatic polyimide membrane containing between 0.05 and 20 wt-% of a poly(styrene sulfonic acid) polymer. These polymers showed up to 95% improvement in selectivity for CO₂/CH₄ and H₂/CH₄ separations over PBO membranes prepared from corresponding aromatic polyimide membranes without a poly(styrene sulfonic acid) polymer. However, no effort has been made to adapt these membranes to the dehydration of ethanol, so no work has been done to improve their chemical stability or tailor their separation properties. The membranes described below have been formulated to have high transport properties and high thermal and chemical stability.

The method described in the present invention provides polymeric membranes with high thermal and chemical stability for ethanol dehydration. The chemical and thermal stability of PBOs, PBIs and PBTs has long been recognized, but their use as membrane materials was limited by their lack of solubility in common solvents, which prevented them from being produced as thin films by solvent casting, which is the dominant membrane fabrication technique. The method of the present invention results in the generation of a polymeric material with high thermal and chemical stability while maintaining permeability and selectivity comparable or superior to industrial membranes. With the proper selection of polymer structure, membranes with even higher productivity might be produced without compromising their stability. The membranes produced herein may also be used for other separations that require dense membranes with high chemical and thermal stability, such as the dehydration of other organic solvents.

### SUMMARY OF THE INVENTION

The present invention describes a new class of polymeric membranes for water/ethanol separations comprising polybenzoxazoles (PBO), polybenzimidazoles (PBI) and polybenzothiazoles (PBT). The membranes in the present invention are synthesized from aromatic polyimides or aromatic polyamides in which ortho positioned functional groups such as alcohols, amines, or thiols are thermally rearranged in the solid state. This rearrangement leads to the development of a unique microstructure, which gives the membrane excellent separation characteristics. PBOs, PBIs and PBTs are known to have high chemical and thermal stability (10), enabling them to withstand the harsh environment encountered in ethanol dehydration. Furthermore, these materials could be used as the selective layer of an asymmetric membrane or, in conjunction with other materials, a composite membrane.

### BRIEF DESCRIPTION OF THE DRAWINGS

For a more complete understanding of the features and advantages of the present invention, reference is now made to the detailed description of the invention along with the accompanying figures and in which:

FIG. 1 is a schematic showing the theorized molecular rearrangement of polyimides containing ortho-positioned functional groups during thermal treatment (X is O, NH or S);

FIG. 2 is a schematic showing the theorized molecular rearrangement of polyamides containing ortho-positioned functional groups during thermal treatment (X is O, NH or S);

FIGS. 3A and 3B are schematic representations of pervaporation (3A) and vapor permeation membrane separation techniques (3B);

FIG. 4 shows the structure of chemically imidized HAB-6FDA polyimide and the expected TR structure;

FIG. 5 is a representation of a lab-scale pervaporation system;

FIG. 6 is a plot showing the water flux of HAB-6FDA-C TR material compared with published results for a UBE polyimide (15);

FIG. 7 is a plot showing the ethanol flux of HAB-6FDA-C TR material compared with published results for a UBE polyimide (15);

FIG. 8 is a plot showing the selectivity of HAB-6FDA-C TR material compared with published results for a UBE polyimide (15);

FIG. 9 is a schematic representation of the synthesis of HAB-6FDA-T polyimide from HAB and 6FDA monomers, thermally imidized in solution, and thermal rearrangement to the corresponding polybenzoxazole or poly(benzoxazole-co-imide);

FIG. 10 depicts an exposure cell for testing the thermal and chemical stabilities of polymer samples, comprising a cell bottom (1002), cell top (1004), clamp (1006), Viton gasket with 10 mesh screen (1008), 0-100 psig pressure gauge (1010), bleed valve (1012), and relief valve (1014);

FIG. 11A shows the TGA heating procedure for the HAB-6FDA-T polyimide where t₀=200° C., and FIG. 11B shows the corresponding TGA mass loss curve;

FIG. 12 shows the ATR-FTIR spectra of HAB-6FDA-T polyimide and corresponding TR polymers;

FIG. 13 shows the exposure test results for the HAB-6FDA-T polyimide, the associated TR polymers, and Matrimid. The samples were exposed to a gaseous water and ethanol mixture, consisting of 50 wt. % water, at 120° C. and 3 bar A for the time periods indicated beside each picture;

FIGS. 14A-14C show TGA and derivative curves of: (14A) Matrimid, (14B) HAB-6FDA-T TR450, and (14C) TR400 films before and after exposure to a gaseous water and ethanol mixture, consisting of 50 wt. % water, at 120° C. and 3 bar A for one week;

FIGS. 15A-15C show ATR-FTIR spectra of: (15A) Matrimid, (15B) TR450, and (15C) TR400 membranes before and after exposure to a gaseous water and ethanol mixture, consisting of 50 wt % water, at 120° C. and 3 bar A for one week.

FIG. 16 is a plot of the calculated (22) permeate ethanol concentration as a function of selectivity. The feed ethanol concentration is 90 wt %.

FIG. 17 shows several potential structures for the TR precursor polyimides.

FIG. 18 shows several potential TR precursor polyamide structures.

FIG. 19 shows several possible TR structures.

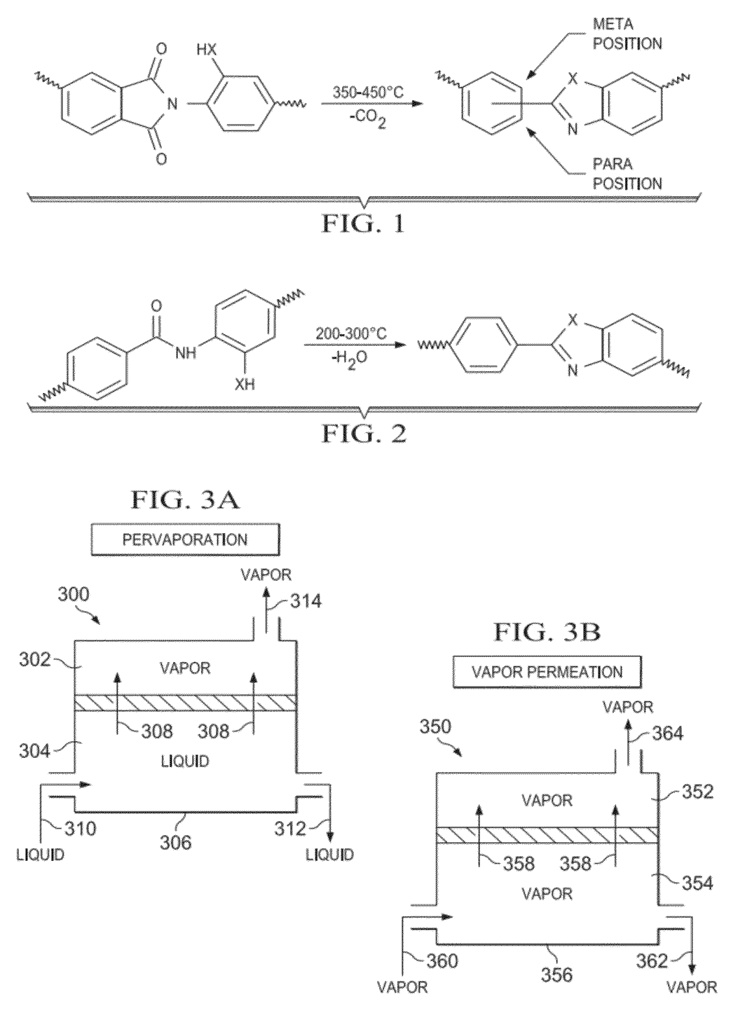

### DETAILED DESCRIPTION OF THE INVENTION

While the production and use of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention; they do not limit the scope of the invention.

To facilitate the understanding of this invention, a number of terms are defined below. Terms defined herein have the meanings commonly understood by a person of ordinary skill in the areas relevant to the present invention. Terms such as “a”, “an” and “the” are not intended to refer to only a singular entity but include the general class, of which a specific example may be used for illustration. The terminology herein is used to describe specific embodiments of the invention, but their usage does not limit the invention, except as outlined in the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” Throughout this application, the term “about” is used to indicate that a value includes the inherent variation of error for the device, the method being employed to determine the value or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C or combinations thereof” is intended to include at least one of: A, B, C, AB, AC, BC or ABC, and if order is important in a particular context, also BA, CA, CB, CBA, BCA, ACB, BAC or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no implied limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods, and in the steps or the sequence of steps of the method described herein, without departing from the concept, spirit and scope of the invention. All such similar substitutes and modifications apparent to those skilled in the art are deemed to be within the spirit, scope and concept of the invention, as defined by the appended claims.

The term Alkyl as used herein refers generally to a linear saturated monovalent hydrocarbon or a branched saturated monovalent hydrocarbon having the number of carbon atoms indicated in the prefix. For example, (C1-C6) alkyl is meant to include methyl, ethyl, n-propyl, 2-propyl, tert-butyl, pentyl, and the like. For each definition herein (e.g., alkyl, alkenyl, alkoxy, aralkyloxy), when no prefix is included to indicate the number of main chain carbon atoms in an alkyl portion, the radical or portion thereof will have six or fewer main chain carbon atoms.

The term Alkylene as used herein refers generally to a linear saturated divalent hydrocarbon or a branched saturated divalent hydrocarbon having the number of carbon atoms indicated in the prefix. For example, (C1-C6) alkylene is meant to include methylene, ethylene, propylene, 2-methylpropylene, pentylene, and the like.

The term Alkenyl as used herein refers generally to a linear monovalent hydrocarbon or a branched monovalent hydrocarbon having the number of carbon atoms indicated in the prefix and containing at least one double bond. For example, (C2-C6) alkenyl is meant to include ethenyl, propenyl, and the like.

The term Alkenylene as used herein refers generally to a linear divalent hydrocarbon or a branched divalent hydrocarbon having the number of carbon atoms indicated in the prefix and containing at least one double bond. For example, (C2-C6) alkenylene is meant to include ethenylene, propenylene, and the like.

The term Alkynyl as used herein refers generally to a linear monovalent hydrocarbon or a branched monovalent hydrocarbon containing at least one triple bond and having the number of carbon atoms indicated in the prefix. For example, (C2-C6) alkynyl is meant to include ethynyl, propynyl, and the like.

The term Alkynylene as used herein refers generally to a linear divalent hydrocarbon or a branched divalent hydrocarbon having the number of carbon atoms indicated in the prefix and containing at least one triple bond. For example, (C2-C6) alkynylene is meant to include ethynylene, propynylene, and the like.

The terms Alkoxy, Aryloxy, Aralkyloxy, or Heteroaralkyloxy as used herein refer generally to a radical —OR where R is, respectively, an alkyl, aryl, aralkyl, or heteroaralkyl as defined herein, e.g., methoxy, phenoxy, benzyloxy, pyridin-2-ylmethoxy, and the like.

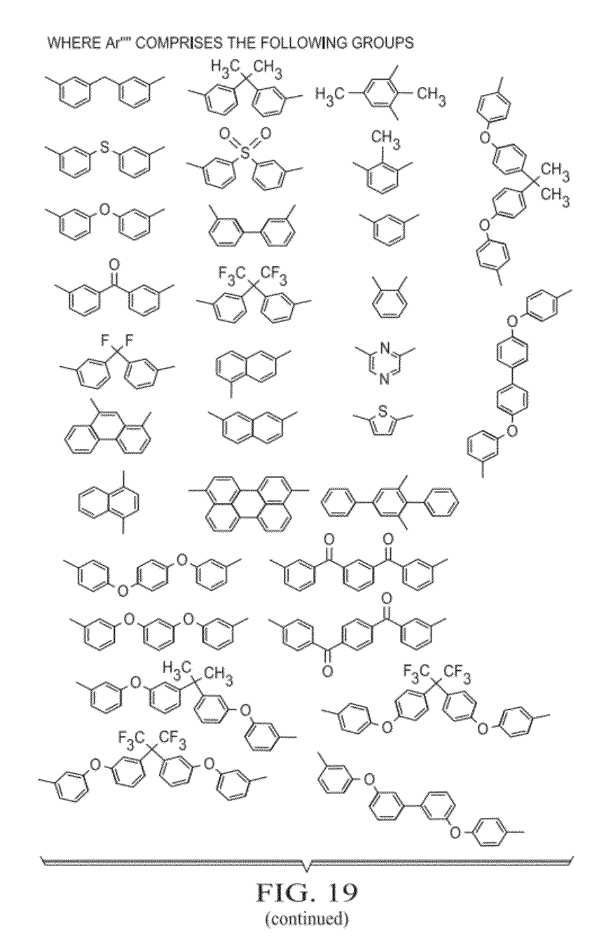

As used herein the terms “polybenzoxazole,” “polybenzoimidazole,” and “polybenzothiazole” or their respective abbreviations, “PBO,” “PBI,” and “PBT” refer to the polymers produced via the solid state thermal treatment of aromatic polyimides or aromatic polyamides with ortho-positioned functional groups such as, but not limited to, —OH, —NH₂, and —SH. The PBO, PBI or PBT polymer structure is expected to be that depicted in FIG. 19 but may consist in part or entirely of other structural elements, including unreacted precursor materials, crosslinked moieties, or products of other solid state, high temperature reactions, including degradation.

As used herein the terms “pervaporation” and “vapor permeation” refer to membrane separation processes that operate on the basis of differences in permeation rate through certain dense, non-porous membranes or the dense, non-porous selective layer of certain asymmetric or composite membranes. When the mixture to be separated is brought as a liquid into contact with the membrane, the process is called “pervaporation.” If the mixture to be separated is gaseous, the term “vapor permeation” is often applied. The polymers described in the present invention may be used in both processes.

As used herein, “feed” refers to the liquid or vapor mixture that is brought into contact with the membrane surface for separation, “permeate” refers to the portion of the liquid or vapor mixture that diffuses across the membrane, and “retentate” refers to the portion of the liquid or vapor mixture that does not pass through the membrane. Accordingly, the term “permeate side” refers to that side of the membrane on which permeate collects, and the term “feed side” or “retentate side” refers to that side of the membrane which contacts the feed liquid or vapor mixture.

As used herein, the term “membrane flux” refers to the flow volume over time per unit area of membrane, e.g., g/sq.cm/hr or ml/min/sq. meter.

As used herein, the term “permeability” is defined as the membrane flux normalized by appropriate thermodynamic driving force and membrane thickness and is therefore a material property.

The term “membrane selectivity”, αₘₑₘ, as used herein, is defined as the ratio of the permeability of the more permeable penetrant to the permeability of the less permeable penetrant and is a measure of the ability of a membrane to separate the two components. (22)

The term “separation factor,” α_{obs}, refers to the ratio of the concentration of the more permeable penetrant to the concentration of the less permeable penetrant substance in the permeate divided by the ratio of compositions in the feed solution or vapor, i.e., α_{obs AB}=(A/B)ₚ/(A/B)_{f}. In this equation, A and B are the contents of water and organic substance in the two systems respectively, and p and f stand for “permeate” and “feed,” respectively.

The synthesis and use of polybenzoxazole (PBO), polybenzimidazole (PBI) and polybenzothiazole (PBT) based membranes for ethanol-water separation is described herein. The membranes are synthesized from aromatic polyimides or aromatic polyamides with ortho positioned functional groups, such as alcohols, amines or thiols, which are thermally rearranged in the solid state. The thermal rearrangement imparts a unique microstructure to give the membrane excellent separation characteristics in conjunction with the pre-existing high chemical and thermal stabilities of the PBOs, PBIs and PBTs. These polymers can be used as standalone membranes or as the selective layer of an asymmetric or composite membrane and may be formed into any convenient geometry.

In applying this polymer system to ethanol dehydration, several variables can be used to optimize performance. First, the chemical structure of the polyimide or polyamide precursor, and thus the resulting PBO/PBI/PBT structure, can be changed to increase the membrane's water flux while retaining high water/ethanol selectivity. Second, the synthesis route of precursor polymers of the same chemical structure has been shown to influence the gas separation properties and may also influence water-ethanol transport properties (23). Finally, the thermal treatment used to convert to the final PBO, PBI or PBT will influence the fraction of the polyimide units that rearrange and which side reactions and crosslinking occur. The optimum combination of structure, synthesis route and rearrangement condition has yet to be determined and is dependent on the overall ethanol dehydration process design.

Two different membrane separation techniques have been considered for ethanol dehydration. The first is pervaporation (FIG. 3A, 300) in which a liquid feed is introduced to the membrane (304) and the permeate produced is a vapor. Separation is therefore based on a combination of permeation and vaporization. The other technique, vapor permeation (FIG. 3B, 350), is similar except that the feed is in the vapor phase when it reaches the membrane (354), thus eliminating the effects of vaporization.

As seen in FIG. 3A, the pervaporation system (300) comprises a chamber (302) that is divided by the pervaporation membrane (304) into a feed side (306) and a permeate side (308). The liquid feed (comprising at least two components) is introduced to the feed side (306) through an inlet (310), and the retentate (enriched in one component) flows out through an outlet (312). The permeate vapor is collected from the permeate side (308) through an outlet (314).

The vapor permeation system (350) as shown in FIG. 3B comprises a chamber (352) that is separated by a membrane (354) into two compartments, feed (356) and permeate (358). A vapor feed mixture comprising at least two components (typically heated and pressurized) is introduced to the feed side (356) through an inlet (360). The vapor permeate enriched in one component is collected from the permeate side (358) through an outlet (364), and a retentate enriched in the other component is collected from the feed side (356) through an outlet (362).

Currently, vapor permeation is expected to be the dominant design in commercial ethanol dehydration plants due to the following two factors. First, in the ethanol/water separation, performing the separation in the vapor state has advantages. The vaporization thermodynamics favor ethanol over water. However, an efficient process design requires the preferential transport of water through the membrane. Thus, in a pervaporation system, the vaporization thermodynamics compete with the membrane selectivity and reduce the overall separation performance of the unit. Second, the feed for the membrane units will come from a distillation column and thus will already be in the vapor phase. There is no advantage to condensing the feed as long as the membrane can tolerate the higher temperatures and associated higher pressures.

On a laboratory scale, however, pervaporation systems are easier and more cost effective to operate, so most studies in the literature are done using this technique. Pervaporation results can be used to estimate vapor permeation behavior by accounting for the differences in driving force between pervaporation and vapor permeation. Pervaporation and vapor permeation through dense membranes are coupled through the material property, permeability (Λᵢ), which is independent of system design. Thus pervaporation experiments can be used to find the membrane permeability (Equation 1, Λᵢ), which is then used to estimate the vapor permeation flux (Equation 2) based on the thermodynamic factors (\hat{φ}ᵢ^{F}) and the system variables (P^{F}, xᵢ, and l). The separation factor, which is a measure of the ability of the membrane to separate the components, is calculated according to Equation 3.

$$\begin{matrix}Pervaporation Flux of Component i \\ {J}_{i}^{PV} = \frac{{Λ}_{i}}{l} {γ}_{i}^{F} {x}_{i} {P}_{i}^{sat} & Equation 1 \\ Vapor Permeation Flux of Component i \\ {J}_{i}^{VP} = \frac{{Λ}_{i}}{l} {\hat{φ}}_{i}^{F} {x}_{i} {P}^{F} & Equation 2 \\ Separation Factor \\ {α}_{obs} = \frac{{y}_{i} / {y}_{j}}{{x}_{i} / {x}_{j}} & Equation 3\end{matrix}$$

Wherein,

Jᵢ^{PV}=Pervaporation flux of component i

Λᵢ=Membrane permeability (material property)

l=Membrane thickness

γᵢ^{F}=Activity coefficient of component i in feed solution

xᵢ=Mole fraction of component i in feed

Pᵢ^{sat}=Vapor Pressure of component i in feed

Jᵢ^{VP}=Vapor permeation flux of component i

\hat{φ}ᵢ^{F}=Fugacity coefficient of component i in feed

P^{F}=Total feed pressure

α_{obs} separation factor of component i to component j

xⱼ=Mole fraction of component j in feed

yᵢ=Mole fraction component i in permeate

yⱼ=Mole fraction component j in permeate

In deriving Equations 1-3, the following assumptions were used (19):

[1] The liquid phase molar volume does not vary significantly with pressure. [2] The permeate pressure is low (typically a vacuum in pervaporation processes), so the permeate gases obey the ideal gas model, and the fugacity coefficient of each species in the permeate is 1. [3] The feed pressure is close to the vapor pressure, so the Poynting factor equals 1. [4] The permeate is typically maintained under high vacuum, so the total permeate pressure (P^{p}) is approximately equal to zero.

These assumptions are valid for the tests described herein but may be relaxed by use of additional thermodynamic modelling.

### Example I

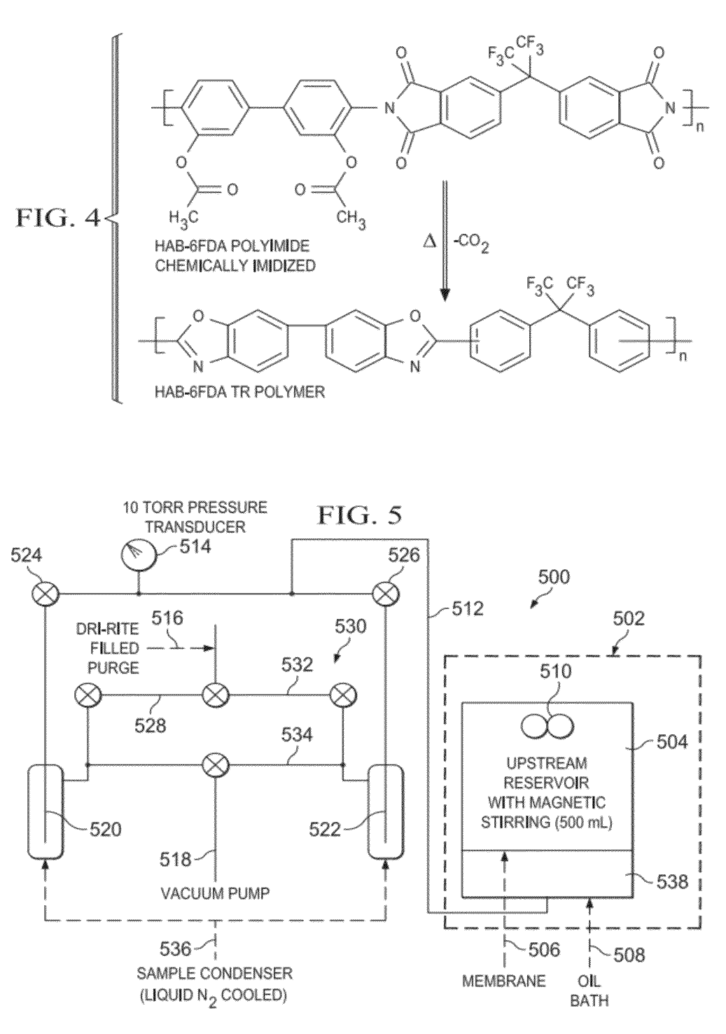

Transport Properties of Chemically Imidized HAB-6FDA TR 350 1 hour. The TR platform of materials was tested for ethanol/water separations using the chemically imidized HAB-6FDA (HAB-6FDA-C) family of TR materials (FIG. 4). This polymer was synthesized by first dissolving 3.5830 grams of 3,3′-dihydroxy-4,4′-diamino-biphenyl (HAB) in 40 mL of dimethylacetamide (DMAc) under nitrogen atmosphere. Next, 7.3609 grams of 2,2′-Bis-(3,4-dicarboxyphenyl)hexafluoropropane dianhydride (6FDA) were added with 16 mL of DMAc, and the reaction was stirred for eight hours. Next, the resulting polyamic acid was chemically imidized by adding 53 mL of DMAc, 25 mL of acetic anhydride and 21 mL of pyridine. The reaction proceeded for 13 hours under nitrogen atmosphere at room temperature. Then the temperature was raised to 60° C. and the reaction was run for another hour (12)(13)(14). The polymer was precipitated in a mixture of 2.0 L of ethanol and 0.5 L of water.

The polymer film was solution cast from a 3.5 wt % solution of solids in chloroform, and the resulting film was dried at room temperature for 24 hours and then dried at 100° C. in a vacuum oven for one day. The polymer was then thermally rearranged to a polybenzoxazole structure by heating a polymer film under a nitrogen atmosphere at 250° C. for 3 hours and then raising the temperature to 350° C. for 1 hour. The resulting film, HAB-6FDA-C TR350-1 hr (FIG. 4), had a thickness of 92.6 microns.

To measure the polymer's pervaporation performance, the sample film was placed in the pervaporation system pictured in FIG. 5 (500). Aluminum tape was adhered to the outside edge of the film to create a sample large enough to seal the upstream (504) from the downstream (538). The feed solution was 60.2% wt ethanol and 39.9% wt water. After the system (500) reached steady state, the permeate was collected using liquid nitrogen cooled sample condensers (520/522). One condenser (520) was alternated with the other condenser (522) approximately every two hours to allow additional permeate to be collected while the first condenser (520) was thawed and weighed. Samples were collected for six to eight hours total at each temperature. Gas chromatography was used to evaluate the permeate ethanol content.

The results for the membrane transport properties are shown in Table 1. The maximum operating temperature was chosen to be below the bubble point of the liquid feed. From the total flux and the downstream ethanol content, the component fluxes and the separation factor were calculated.

TABLE 1
Flux and Permeate Concentration Results for Example I

| Temper- | | | |
|---|---|---|---|
| ature | Total Flux | Mass Fraction | Mass Fraction |
| (° C.) | (g/cm²hr) | Ethanol in Permeate | Water in Permeate |
| 56 | 0.0015 ± 0.0005 | 0.033 ± 0.002 | 0.967 ± 0.002 |
| 66 | 0.0024 ± 0.0003 | 0.030 ± 0.002 | 0.970 ± 0.002 |
| 76 | 0.0034 ± 0.0003 | 0.018 ± 0.001 | 0.982 ± 0.001 |

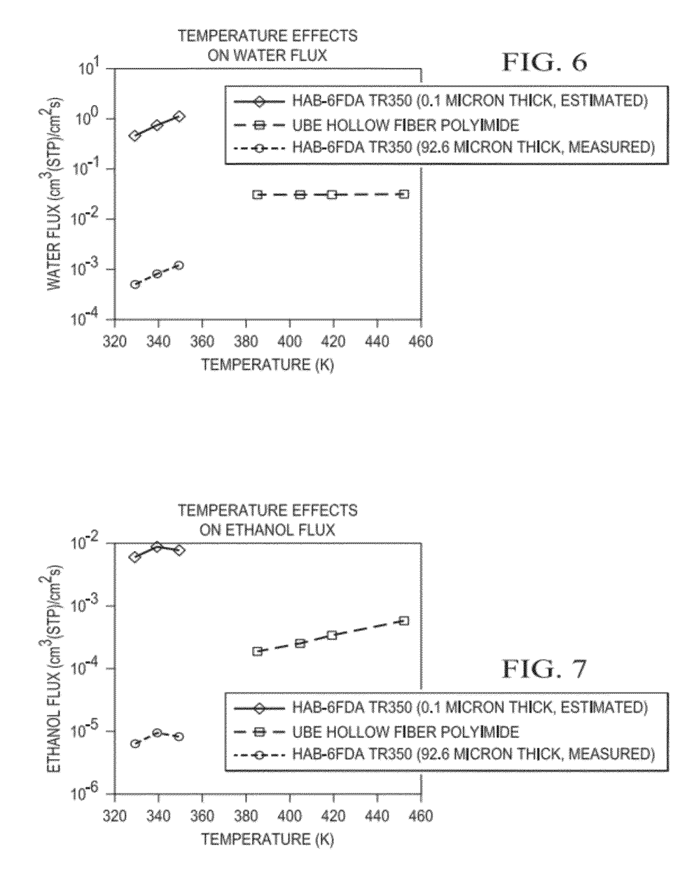

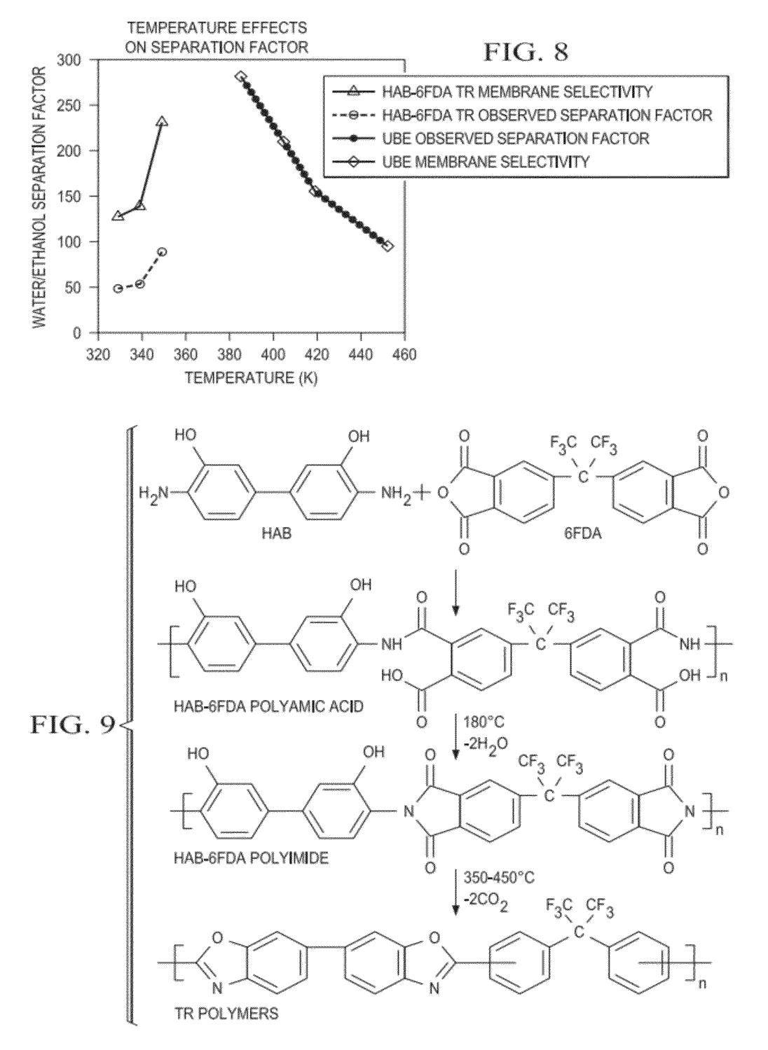

The water flux for both the HAB-6FDA-C TR350-1 hr film and a comparison commercial membrane (15) is shown in FIG. 6. The comparison material is a commercial aromatic polyimide membrane produced by UBE Industries, Ltd. This polymer is structurally similar to the TR precursor polyimide and the ethanol/water vapor permeation characteristics published publicly (15). Since water permeates preferentially, the water flux determines the membrane unit size, meaning that a higher water flux reduces the system's capital cost. Because flux is inversely proportional to membrane thickness (Equation 1), flux comparisons between different membranes cannot be made unless the membranes are of the same thickness. The flux of HAB-6FDA-C TR350-1 hr membrane of any thickness may be calculated once the permeability has been calculated. While the exact thickness of the UBE hollow fiber is unknown, a typical value would be 0.1 microns, and this estimated thickness has been used to adjust the TR membrane flux. Specifically, using Equation 1, the ratio of the fluxes at two thicknesses can be calculated. Since the feed conditions are unchanged and permeability is a material property and is, therefore, unchanged, the ratio of the fluxes is equal to the inverse ratio of the thicknesses, as shown in Equation 4.

$$Flux Adjustment for Different Thickness \\ \frac{{J}_{i , {l}_{1}}^{PV}}{{J}_{i , {l}_{2 }}^{PV}} = \frac{( {Λ}_{i} / {l}_{1} ) {γ}_{i}^{F} {x}_{i} {P}_{i}^{sat}}{( {Λ}_{i} / {l}_{2} ) {γ}_{i}^{F} {x}_{i} {P}_{i}^{sat}} = \frac{{l}_{2}}{{l}_{1}} \qquad Equation 4$$

As shown in FIG. 6, a TR membrane of approximately the same thickness as the UBE hollow fiber would have a higher water flux than the UBE polyimide. The water flux of the TR material increases with temperature because of the inherent increase in the thermodynamic driving force of the pervaporation system with temperature. Increasing the temperature of the pervaporation system increases the water vapor pressure (P_{H}_{₂}_{O}^{SAT}), making water evaporation more favorable. Thus, in pervaporation, water flux increases with temperature.

Equation 4 has also been used to adjust the TR membrane ethanol flux in a hollow fiber membrane. The results (FIG. 7) are similar to those shown for water (FIG. 6). The HAB-6FDA-C TR350-1 hr material has a higher ethanol flux than does the commercial UBE polyimide.

Membrane separation factor (α_{obs}) provides another metric for evaluating membrane performance. However, due to the inherent thermodynamics of the ethanol/water pervaporation system, the observed separation factor (α_{obs}) will be lower than the membrane selectivity (αₘₑₘ). To understand membrane separation performance, the process variables and resulting thermodynamic driving forces must be separated from the membrane selectivity. Restructuring the separation factor equation (Equation 3) and the flux equation (Equation 1) demonstrates that the observed separation factor is the product of the ratio of permeabilities, or membrane selectivity (αₘₑₘ), and a ratio of thermodynamic properties (αₜₕₑᵣₘₒ^{PV}, Equation 5). Using tabulated thermodynamic data and the NRTL Model (16), the vapor pressures (P_{H}_{₂}_{O}^{SAT} and P_{Ethanol}^{SAT}) and activity coefficients (γ_{H}_{₂}_{O}^{F} and γ_{Ethanol}^{F}) can be calculated to estimate the thermodynamic separation factor (αₜₕₑᵣₘₒ^{PV}), which then allows the estimation of the inherent membrane selectivity (αₘₑₘ). Since the thermodynamic separation factor is approximately 0.4 in all cases for the HAB-6FDA-C TR350-1 hr tests, the inherent membrane selectivity is significantly higher than the separation factor (α_{obs}) calculated using Equation 3.

$$Membrane Selectivity Calculation for Pervaporation Membranes \\ {α}_{obs}^{PV} = \frac{{y}_{{H}_{2} O} / {y}_{Ethanol}}{{x}_{{H}_{2} O} / {x}_{Ethanol}} = \frac{{J}_{{H}_{2} O}^{PV} / {J}_{Ethanol}^{PV}}{{x}_{{H}_{2} O} / {x}_{Ethanol}} = \frac{\frac{( {Λ}_{{H}_{2} O} / l ) {γ}_{{H}_{2} O}^{F} {x}_{{H}_{2} O} {P}_{{H}_{2} O}^{sat}}{( {Λ}_{Ethanol} / l ) {γ}_{Ethanol} {x}_{Ethanol} {P}_{Ethanol}^{sat}}}{{x}_{{H}_{2} O} / {x}_{Ethanol}} \\ {α}_{obs}^{PV} = ( \frac{{Λ}_{{H}_{2} O}}{{Λ}_{Ethanol}} ) ( \frac{{γ}_{{H}_{2} O}^{F} {P}_{{H}_{2} O}^{SAT}}{{γ}_{Ethanol}^{F} {P}_{Ethanol}^{SAT}} ) = {α}_{mem} * {α}_{thermo}^{PV} \qquad Equation 5$$

Equation 6 shows the derivation of membrane selectivity (αₘₑₘ) for vapor permeation systems based on Equations 2 and 3. As in the pervaporation case described above, the separation factor (α_{obs}) is the product of the membrane selectivity (αₘₑₘ) and a ratio of thermodynamic factors (αₜₕₑᵣₘₒ^{VP}). The thermodynamic separation factor (αₜₕₑᵣₘₒ^{VP}) is the ratio of the component fugacity coefficients, which can be estimated using the virial equation of state (17)(18). In the UBE hollow fiber tests (15) the resulting thermodynamic separation factor (αₜₕₑᵣₘₒ^{VP}) is less than 1.01. A thermodynamic separation factor (αₜₕₑᵣₘₒ^{VP}) of 1.0 would be obtained if the vapor phase were ideal; therefore, either the gas phase is more thermodynamically ideal than the liquid phase in pervaporation or the components (i.e., water and ethanol) exhibit similar deviations from ideality such that the ratio of their fugacity coefficients is nearly 1. Thus the observed separation factor (α_{obs}) in the vapor permeation system is essentially equal to the membrane selectivity (αₘₑₘ).

$$Membrane Selectivity Calculation for Vapor Permeation Membranes \\ {α}_{obs}^{VP} = \frac{{y}_{{H}_{2} O} / {y}_{Ethanol}}{{x}_{{H}_{2} O} / {x}_{Ethanol}} = \frac{{J}_{{H}_{2} O}^{VP} / {J}_{Ethanol}^{VP}}{{x}_{{H}_{2} O} / {x}_{Ethanol}} = \frac{\frac{( {Λ}_{{H}_{2} O} / l ) {\hat{φ}}_{{H}_{2} O}^{F} {x}_{{H}_{2} O} {P}^{F}}{( {Λ}_{Ethanol} / l ) {\hat{φ}}_{Ethanol} {x}_{Ethanol} {P}^{F}}}{{x}_{{H}_{2} O} / {x}_{Ethanol}} \\ {α}_{obs}^{VP} = ( \frac{{Λ}_{{H}_{2} O}}{{Λ}_{Ethanol}} ) ( \frac{{\hat{φ}}_{{H}_{2} O}^{F}}{{\hat{φ}}_{Ethanol}^{F}} ) = {α}_{mem} * {α}_{thermo}^{VP} \qquad Equation 6$$

The membrane selectivity (αₘₑₘ) of the HAB-6FDA-C TR350-1 hr material is in the same range as that of the UBE polyimide. Overall, the TR material shows comparable or even favorable transport properties relative to a commercial polyimide ethanol/water separation membrane. Furthermore, the TR materials will have favorable chemical and thermal stability relative to other membrane materials, allowing the process to be run under more aggressive feed conditions that will enable a membrane process to compete favorably with the dominant distillation/molecular sieve process. Further improvements in the transport properties are expected as novel TR materials are optimized for this particular separation.

### Example II

Transport Properties and Stability of Thermally Imidized HAB-6FDA and Corresponding TR Polymers. An overview of the synthesis route for thermally imidized HAB-6FDA (HAB-6FDA-T) is shown in FIG. 9. First, the two monomers, 6FDA and HAB, were dried under vacuum for 12 hours at 200° C. and 80° C., respectively. The solvent, 1-methyl-2-pyrrolidinone (NMP) was dried by distilling over calcium hydride for at least 2 hours. The 1,2-dichlorobenzene (ODB) and N,N-dimethylacetamide (DMAc) were used as received. First, 4.3248 g HAB (20 mmol) was dissolved in 57.8 mL of NMP in a 500 mL three-necked round-bottomed flask under nitrogen atmosphere. Then 8.8850 g of 6FDA (20 mmol) were added with 57.8 mL of NMP to make a 10% (w/v) solution. After stirring for 12 hours at room temperature, 77 mL of NMP and 40 mL of ODB were added to the polyamic acid solution. The temperature was raised to 180° C. and held overnight to imidize the polyamic acid. The resulting brown solution was cooled to room temperature, precipitated in deionized water, and then dried in a vacuum oven at 180° C. for 48 hours to give the HAB-6FDA-T polymer.

Next, 6.0 g of HAB-6FDA-T powder were dissolved in 194 g of DMAc to make a 3 wt % solution. The solution was filtered through a 5 μm PTFE syringe filter and cast on a glass plate. The solvent, DMAc, was evaporated in a vacuum oven overnight at 80° C. Then a low vacuum (−10 in. Hg) was applied to slowly remove the solvent. Finally the temperature was increased to 250° C. under full vacuum to remove the solvent completely. The resultant polyimide dense film, 30-50 microns thick, was then thermally rearranged into the corresponding PBO structure by heat treatment at target temperatures of 350° C. for an hour, 400° C. for an hour, or 450° C. for half an hour under nitrogen atmosphere in a tubular furnace. The resultant membrane samples will be referred to as TR350, TR400 and TR450, respectively.

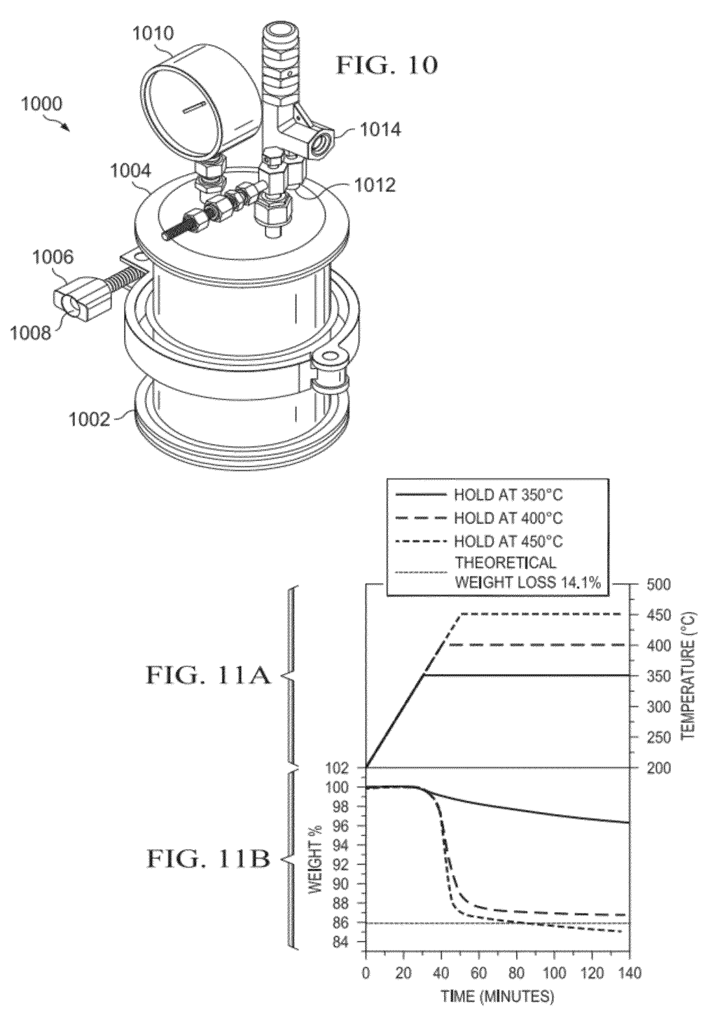

Thermal and chemical stabilities of the precursor polyimide, TR materials and a commercial polyimide, Matrimid, were assessed by exposing the samples to a 50 wt % ethanol mixture at 120° C. and 3 bar A for at least one week. This study simulates, for short periods of time, the rather hostile conditions a membrane might experience in commercial use. An exposure cell (1000) designed for this test is shown in FIG. 10. The cell (1000) comprises a cell bottom (1002) and a top (1004). The cell (1000) also has a clamp (1006) and a Viton gasket with 10 mesh screen (1008). The pressure is monitored with a 0-100 psig pressure gauge (1010) connected to the cell (1000). The cell (1000) has a bleed valve (1012) to control the flow of gas. A relief valve (1014) is also provided to control the pressure in the cell (1000) during testing or because of a system failure.

Five membrane samples, HAB-6FDA-T polyimide, TR350, TR400, TR450 and Matrimid were placed into the cell (1000). The exact amount of ethanol-water mixture was determined experimentally so that the total pressure would reach 3 bar A at 120° C. The cell (1000) was evacuated to remove the air inside, so as to exclude any oxidization effects. Therefore, any possible degradation was due only to ethanol, water and/or heat. The cell was then placed in a convection oven at 120° C. After exposure for a specific period of time, the samples were removed and dried in a vacuum oven at 50° C. for 24 hours to remove residual water and ethanol. The samples were then analyzed by TGA and FTIR to determine the extent of degradation.

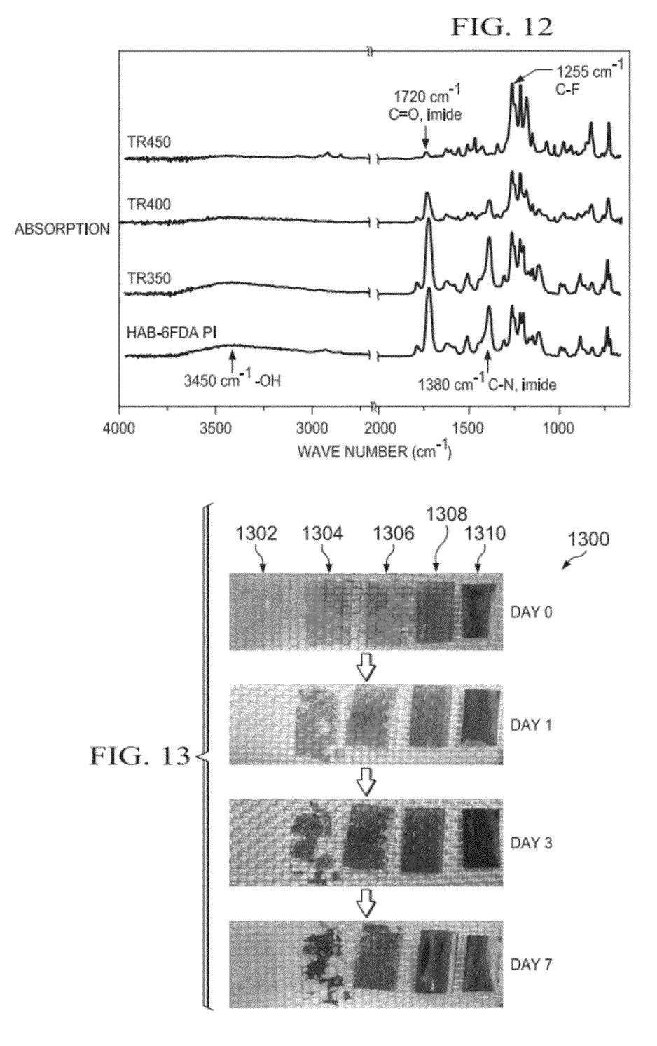

The degree of TR conversion at different temperatures was determined by TGA and FTIR analyses, and the results are shown in FIGS. 11A-11B and 12, respectively. FIG. 11A presents the heating procedure; the temperature first increases from 200° C., at time zero, to the target temperature, which is maintained for up to 2 hours. The mass loss recorded during this procedure is shown in FIG. 11B. Theoretically, 2 CO₂ molecules per repeat unit will be evolved when the polyimide is completely converted to the corresponding polybenzoxazole. Therefore, the theoretical mass loss can be calculated using the following equation:

$$Calculation of Theoretical Mass Loss upon Rearrangement \\ Theoretical weight loss ( \% ) = \frac{2 * Molecular weight of {CO}_{2} ( 2 * 44.0 )}{\begin{matrix}Molecular weight of HAB - 6 FDA - \\ T polyimiderepeating unit ( 624.4 )\end{matrix}} * 100 \% = 14.1 \% \qquad Equation 7$$

The TGA results indicate that the TR conversion is more sensitive to temperature than to time. At a low temperature such as 350° C., the conversion is low and increases slowly over a long period of time. Increasing the temperature to 400° C. causes a rapid weight loss; however, the observed mass loss does not reach the theoretical mass loss. At 450° C., the mass loss exceeds the theoretical value within 35 minutes of reaching the target temperature. The TR450 membrane was prepared by holding at 450° C. for half an hour to maximize conversion, which also minimizes the polyimide residues. Assuming that only the rearrangement reaction happens at the processing conditions, the degree of conversion can be calculated from the TGA data using the following equation:

$$Percent Conversion from Polyimide to Polybenzoxazole by TGA Mass Loss \\ \% conversion by TGA = \frac{Weight loss at a given condition}{Theoretical weight loss} * 100 \% \qquad Equation 8$$

where the theoretical weight loss for this polyimide is 14.1 weight percent.

The conversion results are summarized in Table 2. The samples of TR350, TR400 and TR450 have a degree of TR conversion of 19.1%, 92.9% and 99.3%, respectively. Polymer degradation and carbonization could also occur at rearrangement temperatures of more than 350° C., which would result in a higher mass loss relative to the rearrangement to the PBO structure. Finally, despite drying the film at 250° C. under vacuum for 48 hours, the high Tg (above 300° C.) of the HAB-6FDA-T precursor means that some DMAc likely remains from the film casting process. The residual solvent could be lost during the rearrangement process, resulting in additional mass loss. Therefore, the TGA-based estimation of conversion likely overestimates the actual degree of conversion.

TABLE 2
Estimated TR conversion by TGA and ATR-
FTIR at different processing conditions.

| Sample | Conversion by TGA | Conversion by FTIR |
|---|---|---|
| TR350 | 19.1% | 12.1% |
| TR400 | 92.9% | 60.4% |
| TR450 | 99.3% | 94.2% |

The increase in TR conversion with increased temperature was confirmed by ATR-FTIR analysis (FIG. 12). The precursor HAB-6FDA-T polyimide membrane has a few characteristic absorption bands: 3450 cm⁻¹ (O—H vibrations), 1778 cm⁻¹ (symmetric C═O stretching, imide I), 1720 cm⁻¹ (asymmetric C═O stretching, imide I), 1380 cm⁻¹ (C—N—C stretching, imide II) and 1255 cm⁻¹ (C—F vibrations). As the rearrangement reaction progressed, the absorption peaks of the —OH, imide I and imide II bands gradually diminished, indicating an increase in TR conversion. Over this same progression, the characteristic 1255 cm⁻¹ peak of the C—F group remains at almost the same intensity, indicating that the C—F bond has very high thermal stability. Consequently, this peak was used as an internal standard to estimate the degree of TR conversion, using Equation 9:

$$Percent Conversion from Polyimide to Polybenzoxazole by FTIR \\ \% conversion by FTIR = \frac{\begin{matrix}{A}_{1380} / {A}_{1255} after TR \\ conversion at a given condition\end{matrix}}{{A}_{1380} / {A}_{1255} before TR conversion} * 100 \% \\ {A}_{1380} = Maximum Peak Height of C \text{-} N ( imide II ) Group \\ {A}_{1255} = Maximum Peak Height of C \text{-} F Group \qquad Equation 9$$

The baselines of all spectra were corrected; however, calculation of the extent of conversion assumes that all changes in the height of the imide II peak are due to the conversion of the imide groups PBO groups. IR peak intensity can vary due to changing chemical environments or due to side reactions and degradation. Second, the C—F standard peak overlaps neighboring peaks that are changing over the course of the reaction, making it difficult to accurately calculate the C—F peak height. These factors combine to introduce error into the FTIR-based calculation of TR conversion. The results are shown in Table 2. Samples of TR350, TR400 and TR450 have a degree of TR conversion of 12.1%, 60.4% and 94.2%, respectively, as estimated by this IR technique. Although the exact values are lower, the degree of conversion estimated by FTIR follows the same trend as the TGA-based estimation. The differences in the values calculated by the two techniques are due to the different assumptions inherent in each.

TABLE 3
Ethanol Dehydration Performance of the HAB-6FDA-T
Polyimide and TR Membranes in Pervaporation.

| | Membrane | Water flux | Ethanol flux | Separation | |
|---|---|---|---|---|---|
| | thickness | (cm³ | (cm³ | Factor | Inherent membrane |
| Sample | (μm) | (STP)/(cm²s)) | (STP)/(cm²s)) | (α_{obs}) | selectivity (αₘₑₘ)* |
| HAB-6FDA PI | 35.2 ± 1.0 | 1.98 × 10⁻² | 1.42 × 10⁻² | 3.63 | 4.22 |
| TR350 | 41.5 ± 2.3 | 9.16 × 10⁻³ | 5.98 × 10⁻³ | 5.55 | 6.45 |
| TR400 | 48.6 ± 4.2 | 1.40 × 10⁻³ | 9.87 × 10⁻⁵ | 50.6 | 58.8 |
| TR450 | 43.7 ± 0.9 | 9.78 × 10⁻⁴ | 3.65 × 10⁻⁵ | 96.1 | 112 |

Note:
Test conditions: 90.2 ± 0.1 wt % ethanol, 75° C.; upstream pressure: 1 atm; downstream pressure: <0.1 torr.
*Inherent membrane selectivity was calculated by using Equation 5 with a calculated thermodynamic separation factor of 0.86.

Ethanol dehydration performance of the HAB-6FDA-T polyimide and TR membranes was measured at 75° C. using 90.2±0.1 wt % ethanol as the feed. The upstream pressure was atmospheric; by using a vacuum pump, the downstream pressure was maintained at less than 0.1 torr. The resulting transport properties are given in Table 3. The original HAB-6FDA-T polyimide membrane has a low separation factor but high water flux. As TR conversion increases, both water and ethanol flux decrease, but since the ethanol flux decreases faster, the separation factor (α_{obs}) increases. The membrane selectivity (αₘₑₘ) of the samples can be estimated from Equation 5 with an estimated thermodynamic separation factor (αₜₕₑᵣₘₒ^{PV}) of 0.86 (16). These results suggest that the polybenzoxazoles have much better ethanol-water separation capability than does the precursor polyimide. This polymer also has separation properties comparable to those of the commercial UBE polyimide membrane (15).

FIG. 13 shows the results of the exposure test (1300). Clearly, the polyimide precursor, HAB-6FDA-T (1304), has low stability; polymer degradation begins after only one day of exposure and becomes more severe with time. The color change after exposure is likely due to amine-containing hydrolysis products. However, the TR polymers TR350 (1306), TR400 (1308) and TR450 (1310) show considerably higher stability than their polyimide precursor, and greater stability is achieved with increasing TR conversion. Even after one week of exposure, both TR400 (1308) and TR450 (1310) membrane samples maintain their integrity. A small number of imide bonds remains in the TR400 (1308) (7.1% by TGA and 39.6% by FTIR) and TR450 (1310) (0.7% by TGA and 5.8% by FTIR) samples. Hydrolysis of these bonds is possible and may account for the color change. Even so, the TR400 (1308) and TR450 (1310) membranes retain sufficient mechanical properties to allow the samples to be handled. Although the Matrimid (1302) sample showed no visual change after exposure, the sample became brittle, indicating that some degradation had occurred.

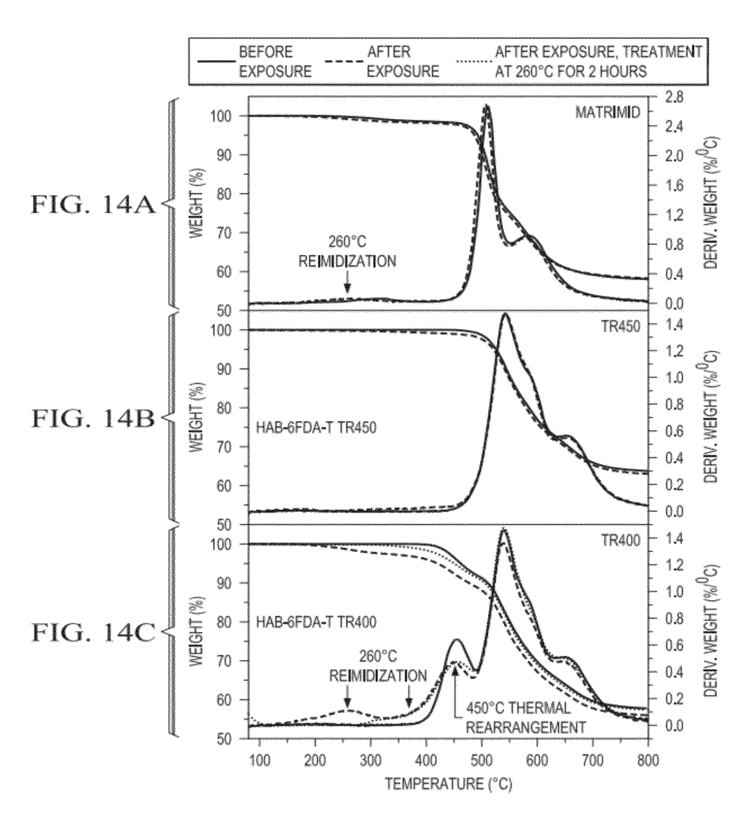

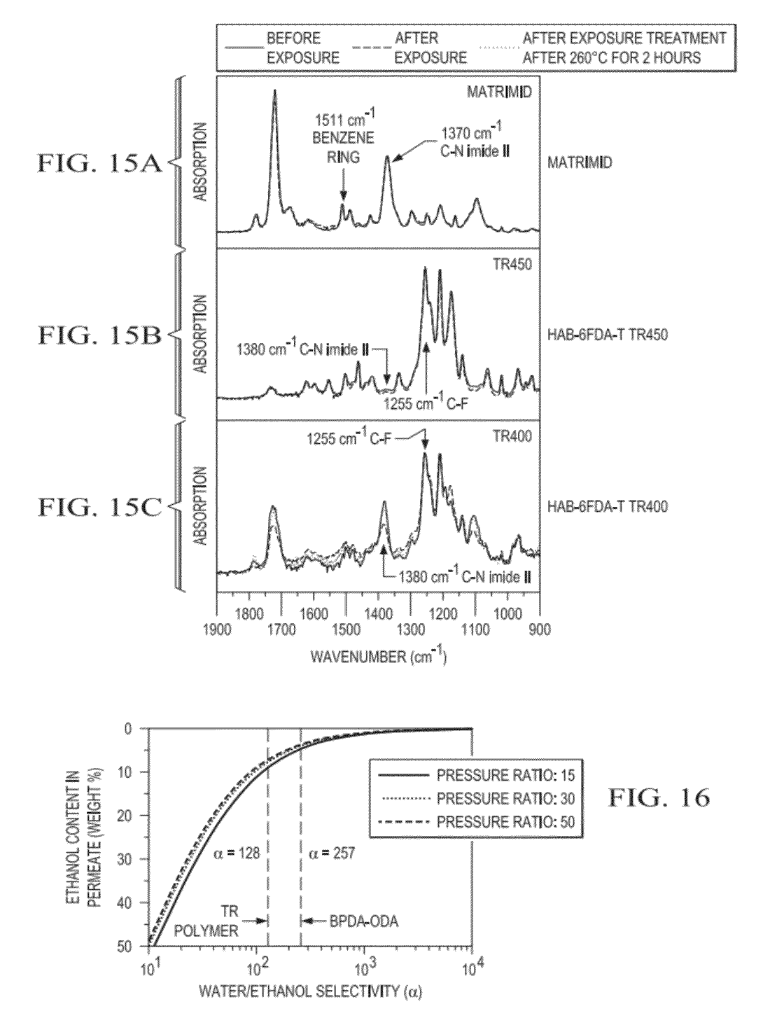

The most likely chemical change in the polyimide and TR polymers during the exposure test is imide ring hydrolysis. FTIR and TGA were used to analyze the TR400, TR450 and Matrimid samples before and after exposure. The TGA results are shown in FIGS. 14A-14C. In FIG. 14C, a new mass loss occurs at 260° C. after exposure of TR400. This peak disappeared after treating the sample at 260′C for 2 hours. However, this heat treatment does not cause the TR400 sample to achieve the same mass loss behavior it exhibited prior to the ethanol/water exposure. Even after holding the exposed sample at 260° C. for 2 hours, the sample begins to lose mass at 280° C. instead of at 380° C., as happened prior to exposure. These results can be explained by the hydrolysis of the residual imide bonds in the TR400 sample, which may degrade into amic acids or even dicarboxylic acids and amines. Although such degradation products can be reimidized at 260° C., the imidization of the mostly PBO sample may be limited by the increased chain stiffness relative to the original HAB-6FDA-T. Higher temperatures may be required to complete the imidization. The imidization reaction also depends on the amic acid group being in the correct conformation to transform into an imide, which could further limit the recovery of the original imide linkages. Thus, residual imide groups in the TR polymers have a negative impact on the membrane stability, and increasing the TR conversion should improve membrane stability. The TR450 sample confirms this hypothesis. As shown in FIG. 14B, The TR450 films exhibit almost identical TGA curves before and after exposure. Since the TR450 has few residual imide groups (0.7% by TGA and 5.8% by FTIR), these results confirm that the PBO structure has excellent resistance to water and ethanol attack, even at high temperature and pressure. Most of the degradation appears to be due to the residual imide linkages. Therefore, in commercial ethanol dehydration, a high conversion of the polyimide to TR polymer is necessary to maximize both selectivity and long-term stability.

Matrimid membrane samples before and after exposure were also tested by TGA. After exposure, the Matrimid TGA curve exhibits a new mass loss at 260° C., which is attributed to the reimidization of hydrolyzed imide bonds. Meanwhile, the thermal degradation peak at 510° C. shifts to slightly lower temperature. These results, combined with the increased sample brittleness, suggest that the imide bonds in Matrimid start to degrade within a week exposure. Therefore, the fully converted TR polymers are more stable than polyimides under commercial ethanol dehydration conditions.

FIG. 15 shows the ATR-FTIR spectra of the previously discussed Matrimid, TR400 and TR450 membranes before and after exposure to a gaseous mixture of water and ethanol, consisting of 50 wt. % water, at 120° C. and 3 bar A for one week. After exposure, the TR400 film exhibits a decrease in both the imide I peak (1720 cm⁻¹) and the imide II peak (1380 cm⁻¹), indicating a decrease in imide content. After treatment at 260° C. for 2 hours, the imide peak heights increase, though not to their pre-exposure values. These results support the TGA results. The FTIR spectra of TR450 and Matrimid are essentially unchanged by the exposure test. Quantitative analysis of the degree of hydrolysis in these samples is necessary to compare the relative stabilities of the TR450 and the Matrimid.

Degree of hydrolysis was determined by FTIR analyses. For the TR400 and TR450 samples, the C—F peak at 1255 cm⁻¹ was used as the internal standard. For each sample, the imide ratio is defined as the ratio of the height of the C—N imide II peak (A₁₃₈₀) to the height of the internal standard peak (A₁₂₅₅). Then the degree of hydrolysis can be estimated from the imide ratios of the samples before and after exposure (Equation 10). However, this calculation accounts only for the percentage of hydrolyzed imide bonds relative to the original number of imide bonds. To understand the impact of the imide hydrolysis on the basis of the entire polymer sample, the percentage of imide hydrolysis must be multiplied by the imide fraction in the overall polymer (Equation 11). The degree of hydrolysis in the Matrimid sample can be estimated by using the benzene ring peak at 1511 cm⁻¹ as the internal standard and the imide II peak at 1370 cm⁻¹ to represent the imide content (Equation 12).

$$Percent of Hydrolyzed Imide Groups Hydrolyzed Relative to Original Imide Content for TR Polymers \\ \% imide hydrolysis = ( \frac{{A}_{1380} / {A}_{1255} after hydrolysis}{{A}_{1380} / {A}_{1255} before hydrolysis} ) * 100 \% \\ {A}_{1380} = Maximum Peak Height of C \text{-} N ( imide II ) Group \\ {A}_{1255} = Maximum Peak Height of C \text{-} F Group \qquad Equation 10$$

Equation 11: Percent of Hydrolyzed Imide Groups in TR Polymer

% TR hydrolysis=% imide hydrolysis*(1−% conversion by FTIR)

% imide hydrolysis is calculated as in Equation 10
% conversion by FTIR is calculated as in Equation 9 for TR polymers,

for pure polyimide it is 100%

$$Percent of Imide Groups Hydrolyzed in Matrimied by FTIR \\ \% hydrolysis of Matrimid = ( 1 - \frac{{A}_{1370} / {A}_{1511} after hydrolysis}{{A}_{1370} / {A}_{1511} before hydrolysis} ) * 100 \% \\ {A}_{1370} = Maximum Peak Height of C \text{-} N ( imide II ) Group \\ {A}_{1511} = Maximum Pe a k Height of Bezene Group \qquad Equation 12$$

The FTIR hydrolysis results are summarized in Table 4. On the basis of the entire polymer, the Matrimid and TR450 percent of hydrolysis is 2.6% and 1.3%, respectively, following exposure. The TR450 sample contains fewer hydrolyzed imide groups than does the Matrimid sample. In addition, the hydrolysis in Matrimid may continue until the entire polymer is hydrolyzed. However, due to its limited imide content (5.8%), the TR450 has a limited number of hydrolysis sites. Thus, the TR polymers will exhibit more long-term hydrolytic stability than polyimides.

TABLE 4
Estimated extent of hydrolysis, as observed with FTIR, following
exposure to a gaseous mixture of water and ethanol, consisting
of 50 wt. % water, at 120° C. and 3 bar A for one week.

| | Degree of | Percentage of | Degree of |
|---|---|---|---|
| | hydrolysis in | imide linkages | hydrolysis in |
| Sample | polyimide part¹ | in the polymer² | the whole polymer³ |
| Matrimid | 2.6% | 100% | 2.6% |
| TR450 | 22.3% | 5.8% | 1.3% |
| TR400 | 34.4% | 39.6% | 13.6% |
| TR400 treated | 29.0% | 39.6% | 11.5% |
| at 260° C. | | | |
| for 2 hrs | | | |

Note:
¹Calculated by Equation 10 for TR polymers and Equation 12 for Matrimid
²Calculated by Equation 9 for TR polymers. Matrimid is 100% polyimide.
³Calculated as Equation 11

The HAB-6FDA-T TR materials show very good transport properties with feed mixtures containing 90 wt % ethanol. The TR reaction improves the membrane chemical stability over that of the polyimide precursor. This improvement in chemical stability will allow the dehydration to be performed at higher temperatures, higher pressures and with higher water contents than are currently possible for membranes. These conditions improve the energy integration and membrane efficiency and will allow membrane processes to compete more favorably with the dominant distillation/molecular sieve process. Further improvements in chemical stability and transport properties are expected as novel TR materials based on HAB-6FDA and other polyimides or polyamides are developed and optimized for ethanol dehydration.

### Example III

Influence of Ethanol/Water Exposure on Transport Properties for HAB-6FDA-T TR450. For further evaluation of membrane stability, two polymer films, HAB-6FDA-T TR450 and BPDA-ODA were prepared. UBE Industries, Ltd produces BPDA-ODA as hollow fiber membranes (20), and they advertise that they sell alcohol dehydration membranes (15), making BPDA-ODA a relevant reference material. The BPDA-ODA film was prepared from 4,4-biphthalic anhydride, (BPDA, 97+%, TCI) and oxydianiline (ODA, 99%, TCI). First, ODA was added into a flask and dissolved in NMP with stirring. After 20 min, an equimolar amount of BPDA was added with additional NMP to make a total concentration of ODA and BPDA of 10 wt %. The reaction was conducted at room temperature with stirring under nitrogen for approximately 20 hours, resulting in a poly(BPDA-ODA) amic acid solution. The solution was filtered through a 5 μm PTFE syringe filter and cast on a glass plate to produce a film for testing. The solvent, NMP, was evaporated overnight under N₂ atmosphere at 80° C. The film was then imidized by increasing the temperature to 200° C. and holding for 1 hour under vacuum. Finally, the temperature was increased to 250° C. and the film held overnight under full vacuum to ensure solvent removal. The preparation process for HAB-6FDA-T TR450 was given previously (Example II).

Both TR450 and BPDA-ODA films were exposed to a gaseous mixture of 50:50 (w/w) water and ethanol, at 120° C. and 3 bar for 1 to 2 weeks using the exposure cell (1000, FIG. 10). Exposure effects were evaluated using both ethanol dehydration and gas permeability measurements. The ethanol dehydration performance was measured at 75° C. with a 90 wt % ethanol feed. The results are shown in Table 5 with the water (Λ_{H}_{₂}_{O}) and ethanol permeability (Λ_{Ethanol}) calculated by Equation 1 and the selectivity of H₂O/Ethanol (αₘₑₘ) calculated by Equation 5.

TABLE 5
Ethanol dehydration results for TR450 and BPDA-ODA before and
after exposure to a gaseous mixture of water and ethanol.

| | Exposure | | | |
|---|---|---|---|---|
| | period | Permeability^{d} (Barrer) | | Selectivity^{d} |
| Sample | (week)^{a} | Water | Ethanol | (αₘₑₘ) |
| TR polymer^{b} | 0 | 2.4 ± 0.4 × 10³ | 19.5 ± 5.4 | 131 ± 43 |
| (HAB-6FDA, | 1 | 2.2 ± 0.2 × 10³ | 15.3 ± 2.3 | 143 ± 25 |
| TR450-0.5h) | 2 | 2.5 ± 0.3 × 10³ | 20.4 ± 4.9 | 128 ± 34 |
| BPDA-ODA^{c} | 0 | 4.4 ± 0.4 × 10² | 0.1 ± 0.01 | 3960 ± 518 |
| (similar to | 1 | 4.9 ± 0.4 × 10² | 1.6 ± 0.1 | 302 ± 36 |
| UBE polymer) | 2 | 5.0 ± 0.4 × 10² | 2.0 ± 0.2 | 257 ± 28 |

Note:
^{a}Exposure conditions: 120° C., 3 bara, 50% ethanol and 50% water.
^{b}Thickness: 70.7 ± 6.1 μm; Area: 42 cm².
^{c}Thickness: 32.7 ± 2.4 μm, Area: 42 cm².
^{d}Test Conditions: Temperature: 75° C.; Upstream pressure: 1 atm; Downstream pressure: <0.1 torr; Feed: 90 wt % ethanol

Helium and nitrogen gas flux was measured by using a constant volume/variable pressure method (21) at 35° C. with pure gas feeds (Table 6). Permeability was then calculated using Equation 13; He/N₂ selectivity (αₘₑₘ) was calculated with Equation 14.

$$\begin{matrix}Calcuation of gas permability by a constant volume / variable pressure method \\ {P}_{i} = \frac{{V}_{D} l}{{p}_{2} ART} [ {( \frac{d {p}_{1}}{d t} )}_{ss} - {( \frac{d {p}_{1}}{d t} )}_{leak} ] & Equation 13 \\ Calculation of Membrane Selectivity for Gas Permeation \\ {α}_{mem} = \frac{{P}_{i}}{{P}_{j}} \\ Wherein \\ {P}_{i} = Permeability of component i \\ {P}_{j} = Permeability of component j ( less permeable than component i ) \\ {V}_{D} = Downstream volume ( {cm}^{3} ) \\ l = Membrane thickness \\ {p}_{2} = Upstream absolute pressure ( cmHg ) \\ A = Film area available for transport ( {cm}^{2} ) \\ R = Gas constant ( 0.278 \frac{cmHg {cm}^{3}}{{cm}^{3} ( STP ) K} ) \\ T = Temperature ( K ) \\ {( \frac{d {p}_{1}}{d t} )}_{ss} = Steady state downstream pressure rise at fixed upstream pressure ( \frac{cmHg}{s} ) \\ {( \frac{d {p}_{1}}{d t} )}_{leak} = Steady state downstream pressure rise with upstream under vacuum ( \frac{cm Hg}{s} ) \\ {α}_{mem} = membrane selectivity & Equation 14\end{matrix}$$

TABLE 6
Gas separation performance for TR450 and BPDA-ODA before and after exposure to a
gaseous ethanol/water mixture.

| | | | Exposure | Gas Permeability | | |
|---|---|---|---|---|---|---|
| | Thickness | | period | (Barrer)^{b} | | Selectivity |
| Sample | (μm) | Area (cm²) | (week)^{a} | N₂ | He | (αₘₑₘ) |
| TR polymer | 38.4 ± 0.5 | 1.74 ± 0.08 | 0 | 2.4 ± 0.1 | 68.4 ± 3.5 | 29 ± 2 |
| (HAB- | 42.8 ± 1.1 | 1.90 ± 0.07 | 1 | 2.4 ± 0.1 | 71.4 ± 3.2 | 30 ± 2 |
| 6FDA, | 38.8 ± 1.8 | 1.80 ± 0.03 | 2 | 2.5 ± 0.1 | 67.5 ± 3.3 | 27 ± 2 |
| TR450-0.5 h) | | | | | | |
| BPDA-ODA | 36.0 ± 4.5 | 4.67 ± 0.13 | 0 | 9.3 ± 1.2 × 10⁻³ | 2.4 ± 0.3 | 257 ± 48 |
| (similar to | 30.8 ± 0.8 | 4.74 ± 0.02 | 1 | 1.4 ± 0.04 × 10⁻² | 2.7 ± 0.1 | 190 ± 8 |
| UBE | 32.3 ± 1.8 | 4.67 ± 0.08 | 2 | 2.1 ± 0.1 × 10⁻² | 3.7 ± 0.2 | 169 ± 14 |
| polymer) | | | | | | |

Note:
^{a}Exposure conditions: 120° C., 3 bar A, 50% ethanol and 50% water.
^{b}Test Conditions: Temperature: 35° C.; Upstream pressure: 200 psig; Downstream pressure: 10-30 mtorr;

The BPDA-ODA polymer shows significant degradation of both He/N₂ and Water/Ethanol selectivity after one week of exposure. This selectivity degradation continued through the second week. In contrast, the TR polymer shows no degradation in selectivity following the same exposure. These results confirm that the polyimides are subject to hydrolysis at the vapor permeation operating conditions, resulting in a gradual decrease in separation performance. In contrast, TR polymers have very stable performance.

TR450, although less selective than BPDA-ODA, is >5 times more permeable towards water than BPDA-ODA. This higher water permeability reduces the membrane area (i.e., capital costs) required to dehydrate a given feed. Also, the high selectivity of the BPDA-ODA polymer is of little practical use because a commercial ethanol/water separation would operate at ratios of feed to permeate pressure that cannot take advantage of such high selectivity (22). Typical practical pressure ratios are in the range of 15-50. At a particular pressure ratio (15, 30 or 50), the impact of selectivity on ethanol loss in the permeate can be simulated by Equation 15.

$$Calculation of Ethanol Loss in Permeate \\ {y}_{EtOH} = 1 - \frac{ϕ}{2} [ \begin{matrix}{y}_{{i}_{0}} + \frac{1}{ϕ} + \frac{1}{{α}_{mem} - 1} - \\ \sqrt{{( {y}_{{i}_{0}} + \frac{1}{φ} + \frac{1}{{α}_{mem} - 1} )}^{2} - \frac{4 {y}_{{i}_{0}} {α}_{mem}}{( {α}_{mem} - 1 ) ϕ}}\end{matrix} ] \\ Wherein \\ {y}_{EtOH} = mole fraction of ethanol in the permeate \\ ϕ = pressure ratio = \frac{{P}^{F}}{{P}^{P}} \\ {P}^{F} = total feed pressure ( 5 bar A ) \\ {P}^{P} = total permeate pressure ( 0.1 - 0.5 bar A ) \\ {y}_{i 0} = mole fraction of water in feed ( 10 \% wt = 22.1 \% mol ) \\ {α}_{mem} = membrane selectivity \qquad Equation 15$$

The goal of the separation process is to minimize the amount of ethanol in the permeate (y_{EtOH}), because any ethanol that permeates through the membrane is either eliminated as waste or recycled back to the distillation column. Ethanol lost as waste reduces the amount of ethanol product produced per unit input. Ethanol recycled to the distillation column increases the energy cost of the ethanol production. FIG. 16 presents the permeate ethanol concentration, y_{EtOH}, calculated from Equation 15, as a function of selectivity, αₘₑₘ, for three representative pressure ratios. The feed ethanol concentration is 90 wt %. For a given pressure ratio and a selectivity below 100, permeate ethanol concentration (y_{EtOH}) is significantly reduced by increasing the membrane selectivity (αₘₑₘ). This region is termed the selectivity limited regime (22). However, once membrane selectivity (αₘₑₘ) rises above 100, the ethanol concentration of the permeate becomes less sensitive to membrane selectivity (αₘₑₘ), and the amount of ethanol lost becomes limited by the low pressure ratio (φ) of a commercial process. For example, increasing the selectivity from 128 (TR450) to 257 (BPDA-ODA) results in less than a 4% decrease in permeate ethanol concentration. This high selectivity region is called the pressure-ratio limited regime. In this regime, a highly selective membrane produces negligible improvements and increasing the flux will prove more cost effective.

Because of their good transport properties and better long-term stability, TR polymers are better candidates than polyimides for ethanol dehydration by both pervaporation and vapor permeation processes. TR polymer structures give higher water permeability and reasonable selectivity without compromising polymer stability.

It should be apparent to one of ordinary skill in the art that other synthesis routes exist both for the HAB-6FDA based polymers described in the proceeding examples and for other potential structures. The properties of the final PBO, PBI or PBT polymer are dependent on the synthesis route, as demonstrated by the differing transport properties reported between the TR samples described in Example I and those in Examples II and III. Several specific considerations are described in the following examples; however, these examples should not be considered an exhaustive list of all synthetic opportunities.

### Example IV

Polyimide and Polyamide Precursors. Using an aromatic polyamide instead of an aromatic polyimide precursor for the thermal rearrangement reaction will result in different properties in the final PBO, PBI or PBT polymer, even if they rearrange to the same nominal structure. Differences could arise from variations in molecular weight, precursor chain flexibility, chain packing, inter- or intra-molecular interactions or other properties. Being able to use polyimide or polyamide chemistry allows further flexibility in the development of TR membranes with properties tuned for ethanol dehydration.

### Example V

Polyimide Synthesis Route. The PBO, PBI and PBT properties are influenced by the route used to synthesize the aromatic polyimide or aromatic polyamide precursor. The most common synthesis routes for polyimides first condense a dianhydride and diamine to a polyamic acid, followed by imidizing the polyamic acid via one of several routes. The most common imidization routes include solid state thermal, solution thermal and chemical imidization.

Solid state thermal imidization involves casting a polyamic acid film or hollow fiber, which is then held at an elevated temperature, typically higher than 250° C., until the imidization is complete. The resulting polyimide is generally insoluble in any solvents due to the crosslinking that occurs during the solid state reaction. This technique is especially useful when the resulting polyimide would not have been soluble even without crosslinking. This synthetic route was used in the synthesis of BPDA-ODA, as described in Example III.

Solution thermal imidization involves dissolving the polyamic acid in a solvent or mixture of solvents with a high enough boiling point to raise the temperature of the solution to the imidization temperature, typically above 180° C. Once the polymer is imidized completely, the polyimide can be precipitated in a nonsolvent, such as water. The route can produce a soluble polyimide and is the method used for the TR samples in Examples II and III.

Chemical imidization typically proceeds by adding excess anhydride and pyridine to the polyamic acid solution as described in Example I. The ortho-functional groups present on the diamine monomer in the TR precursor may also react with the anhydride used in the chemical imidization. This changes the structure of the ortho-group in the precursor polyimide. When a precursor synthesized by chemical imidization undergoes thermal rearrangement, the resulting PBO, PBI or PBT will have different transport properties than will the same polymer produced by thermal imidization in solution. This change in performance may be due to the larger functional groups of the chemically imidized samples creating larger free volume elements as they leave, or because the loss of the functional group as an acid catalyzes the reaction to form PBO, PBI or PBT. The change in polymer properties based on the identity of the ortho-functional group provides the opportunity to tailor the final structure of the PBO, PBI or PBT by addition of specific structures to the ortho-functional group prior to rearrangement.

Other existing synthesis routes and monomer pretreatments include the so-called ester-acid route and a silylation pretreatment used to increase the nucleophilicity of the diamine. These routes, as well as others not described here, offer additional methods for tuning the properties of the TR polymers for ethanol dehydration.

### Example V

Polymer Rearrangement. The reaction of the aromatic polyimide or aromatic polyamide to form the PBO, PBI or PBT structure has typically been done in the solid state at elevated temperatures in a non-oxidizing atmosphere. However, the optimum temperature and time of treatment will be dependent on the polymer structure. Different polymer backbones have different flexibilities and reactivities, and the rate and temperature dependence of the reaction will therefore depend on the polymer structure. One example of this is that most polyimide precursors require temperatures over 350° C. in order to form the PBO, PBI, or PBT structure, while most polyamides can form similar structures at temperatures below 300° C. The temperature and treatment time clearly influence the final polymer structure, as shown in the previous examples. Also, when the rearrangement temperature is low enough to prevent the oxidation of the polymer backbone, the reaction may be done in air without wide scale polymer degradation. Each of these factors—time, temperature and atmosphere—will have to be optimized to develop the best protocol for a commercial membrane.

It should be apparent to one of ordinary skill in the art that many structures are possible beyond the HAB-6FDA based polymers described above. Any polymer with similar functionality, including aromatic polyimides and polyamides with ortho-positioned functional groups, could undergo similar rearrangement chemistry and produce PBO, PBI or PBT membranes. Several examples of potential structures are given below, although this list is not exhaustive.

### Example VI

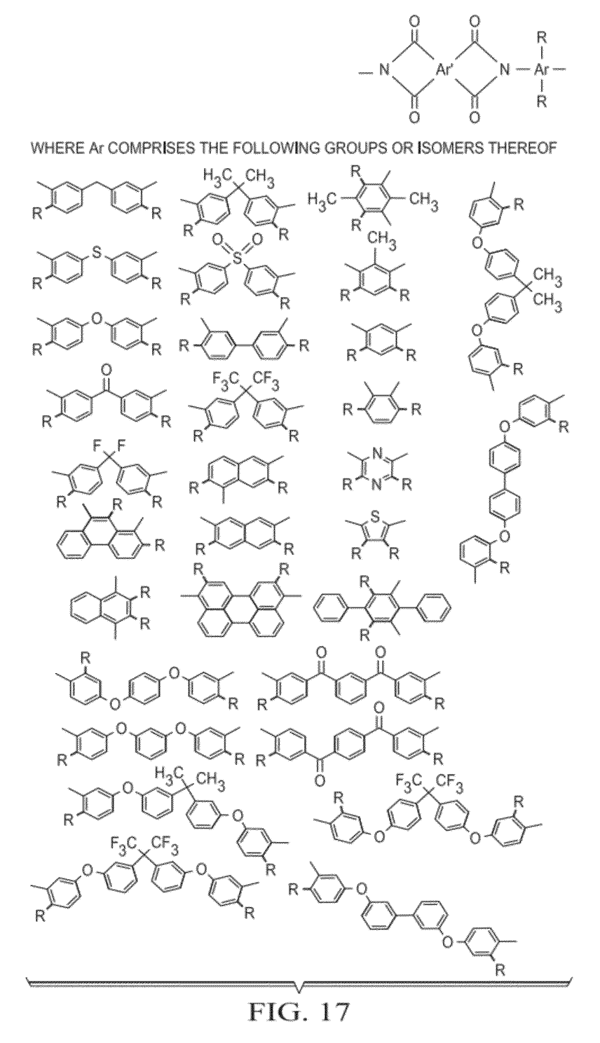

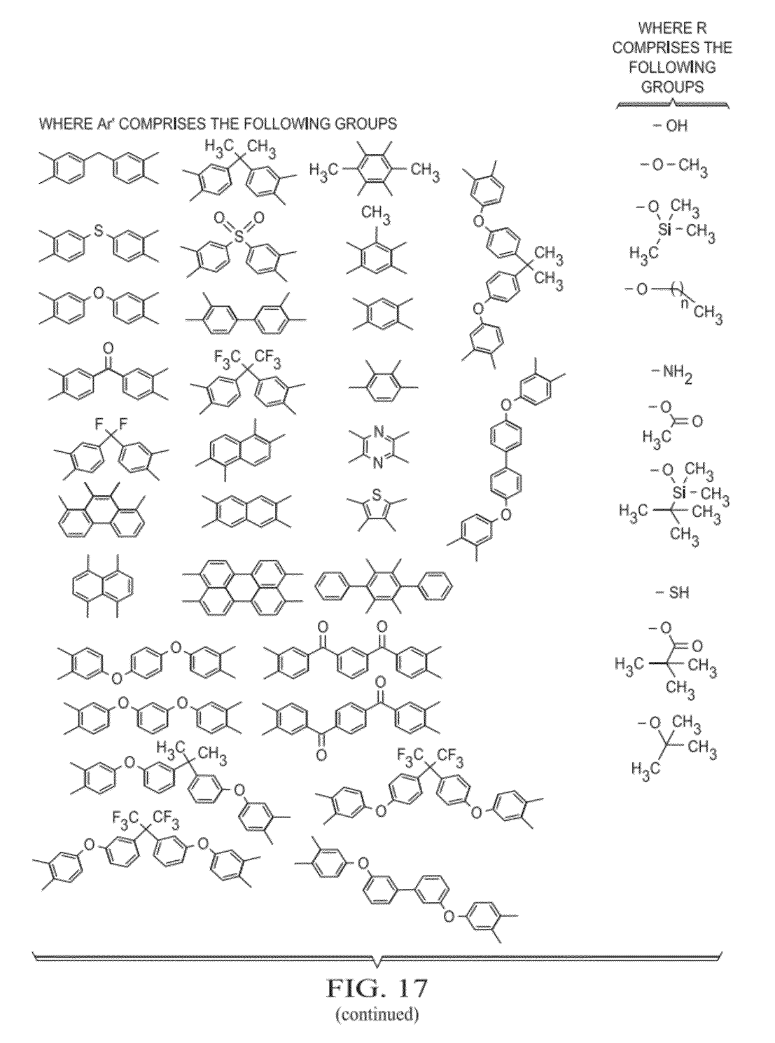

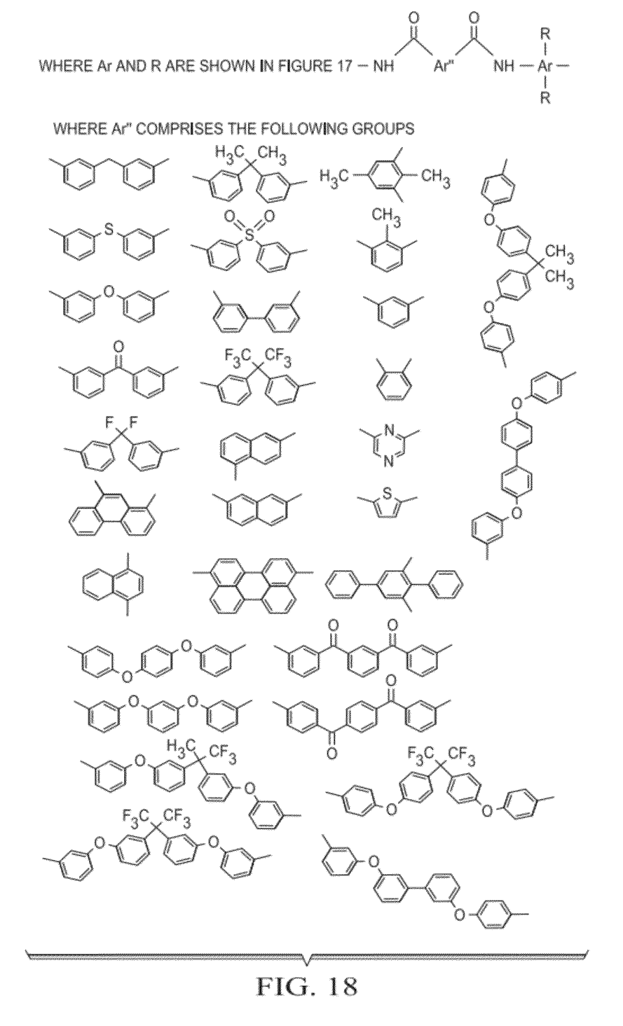

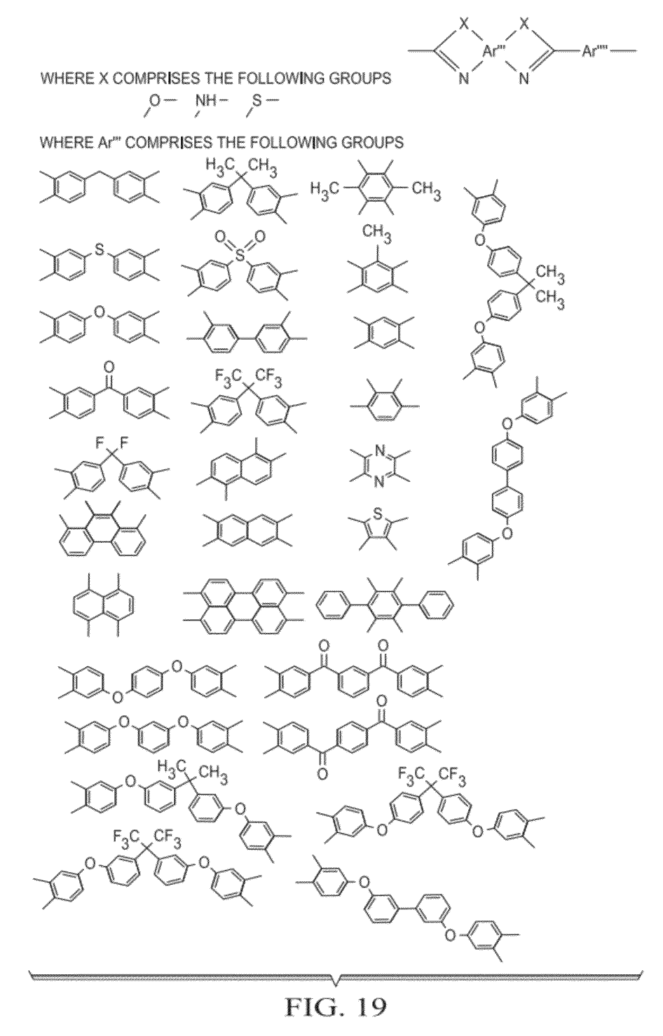

Potential Precursor Structures. The present invention provides for precursor polymers that undergo a solid state, high temperature reaction to form the PBO, PBI or PBT structure. These precursor polymers comprise the repeating unit of a formula as pictured in FIG. 17 and FIG. 18 or isomers thereof.

### Example VII

Potential PBO/PBI/PBT Structures. The present invention provides for PBO, PBI or PBT structures that are formed by the solid state, high temperature reaction of an aromatic polyimide or aromatic polyamide with ortho-positioned functional groups. These PBO, PBI or PBT structures comprise the repeating unit of a formula pictured in FIG. 19 or isomers thereof.

Diamine include as examples 3, 3′-hydroxy-4,4′-diamino-biphenyl (HAB); 2,2-bis(3-amino-4-hydroxyphenyl)-hexafluoropropane (APAF); 2,5-diamino-1,4-Benzenediol; 2,5-diamino-1,4-Benzenedithiol (DABT); 4,4′-(1-methylethylidene)bis[2,6-diaminophenol]; 2,2-Bis(3-amino-4-hydroxyphenyl)propane; 3,3′-Diamino-4,4′-dihydroxydiphenylmethane; 4,4′-ethylidenebis[2-amino-3,6-dimethylphenol]; 3,3′-Diaminobenzidine; 4,4′-methylenebis[2-amino-3,6-dimethylphenol]; 4,4′-[2,2,2-trifluoro-1-[3-(trifluoromethyl)phenyl]ethylidene]bis[2-aminophenol]; 4,4′-[1-[4-[1-(3-amino-4-hydroxyphenyl)-1-methylethyl]phenyl]ethylidene]bis[2-aminophenol]; and combinations thereof. However the skilled artisan will be able to identify other compositions that will be applicable.

Dianhydride include as examples 3,3′,4,4′-Benzophenone tetracarboxylic dianhydride; Pyromellitic dianhydride; 3,3′,4,4′-biphenyl tetracarboxylic dianhydride; 2,2′-bis-(3,4-dicarboxyphenyl)hexafluoropropane dianhydride (6FDA); 4,4′-oxydiphthalic anhydride; 3,3′,4,4′-diphenylsulfone tetracarboxylic dianhydride; 4,4′-bisphenol A dianhydride; Hydroquinone diphthalic anhydride; 5-(2,5′-dioxotetrahydrol)-3-methyl-3-cyclohexene-1,2-dicarboxylic anhydride; Ethylene glycol bis(trimellitic anhydride); 2,3,3′,4′-biphenyltetracarboxylic acid dianhydride; Naphthalene-1,4,5,8-tetracarboxylicdianhydride; 3,3′4,4′-diphenylsulfonetetracarboxylic dianhydride; 3,4,9,10-perylenetetracarboxylic dianhydride; and combinations thereof. However the skilled artisan will be able to identify other compositions that will be applicable.

Co-Diamines (non-rearranging) include as examples 2,3,5,6-tetramethyl-1,4-phenylenediamine (4MPD); 2,4,6-trimethyl-m-phenylenediamine (3MPD); Acetoguanamine; 4,4′-oxydianiline; 3,4′-oxydianiline; 3,3′,5,5′-tetramethyl-4,4′-diaminodiphenylmethane; 1,3-bis(4-aminophenoxy)benzene; 4,4′-bis(4-amino-2-trifluoromethylphenoxy)biphenyl; 2,2′-bis(trifluoromethyl)benzidine; 2,2-bis(4-(4-aminophenoxy)phenyl)hexafluoropropane; 1,4-bis(4-amino-2-trifluoromethylphenoxy)benzene; and combinations thereof. However the skilled artisan will be able to identify other compositions that will be applicable.

The present invention provides a membrane module for dehydrating an organic mixture or separating a liquid mixture having a perm-selective polymeric membrane module comprising polybenzoxazole (PBO), polybenzimidazole (PBI), or polybenzothiazoles (PBT), wherein the perm-selective polymeric membrane module comprises a selective layer of the perm-selective polymeric membrane module comprising a thermally rearranged aromatic polyimide (API) or aromatic polyamide (APA) precursor with a functional group in an ortho position relative to a nitrogen atom of an imide or the amide ring of the API or APA precursor, a membrane feed side of the perm-selective polymeric membrane module adapted to contact a liquid mixture to be separated; and a membrane permeate side opposite to the membrane feed side that is adapted to be maintained at a lower pressure.

The PBO, PBI or the PBT are made from a thermally treated polycondensation polyimide or polyamide comprising a dianhydride or dianhydride mixture along with a diamine or a diamine mixture or a diacid halide or a diacid halide mixture along with a diamine or a diamine mixture.

The dianhydride may be 3,3′,4,4′-Benzophenone tetracarboxylic dianhydride; Pyromellitic dianhydride; 3,3′,4,4′-biphenyl tetracarboxylic dianhydride; 2,2′-bis-(3,4-dicarboxyphenyl)hexafluoropropane dianhydride (6FDA); 4,4′-oxydiphthalic anhydride; 3,3′,4,4′-diphenylsulfone tetracarboxylic dianhydride; 4,4′-bisphenol A dianhydride; Hydroquinone diphthalic anhydride; 5-(2,5′-dioxotetrahydrol)-3-methyl-3-cyclohexene-1,2-dicarboxylic anhydride; Ethylene glycol bis(trimellitic anhydride); 2,3,3′,4′-biphenyltetracarboxylic acid dianhydride; Naphthalene-1,4,5,8-tetracarboxylicdianhydride; 3,3′4,4′-diphenylsulfonetetracarboxylic dianhydride; 3,4,9,10-perylenetetracarboxylic dianhydride; and combinations thereof;

The diacid halide or a diacid halide mixture may be [1,1′-Biphenyl]-3,3′-dicarbonyl dichloride, [1,1′-Biphenyl]-4,4′-dicarbonyl dichloride, [1,1′-Biphenyl]-3,4′-dicarbonyl dichloride, 4,4′-(1-methylethylidene)bis-benzoyl chloride, 4,4′-[2,2,2-trifluoro-1-(trifluoromethyl)ethylidene]bis-benzoyl chloride, 9,9-dioctyl-9H-Fluorene-2,7-dicarbonyl dichloride, 9,9-dimethyl-9H-Fluorene-2,7-dicarbonyl dichloride, 1,4-Benzenedicarbonyl dichloride, 1,3-Benzenedicarbonyl dichloride, 4,4′-[2,2,2-trifluoro-[3-(trifluoromethyl)phenyl]ethylidene]bis-benzoyl chloride, 4,4′-oxybis-benzoyl chloride, 4,4′-carbonylbis-benzoyl chloride or combinations thereof;

The diamines may be selected from the group consisting 2,3,5,6-tetramethyl-1,4-phenylenediamine (4MPD), and 2,4,6-trimethyl-m-phenylenediamine (3MPD); 3,3′-hydroxy-4,4′-diamino-biphenyl (HAB); 2,2-bis(3-amino-4-hydroxyphenyl)-hexafluoropropane (APAF); 2,5-diamino-1,4-Benzenediol; 2,5-diamino-1,4-Benzenedithiol (DABT); 4,4′-(1-methylethylidene)bis[2,6-diaminophenol]; 2,2-Bis(3-amino-4-hydroxyphenyl)propane; 3,3′-Diamino-4,4′-dihydroxydiphenylmethane; 4,4′-ethylidenebis[2-amino-3,6-dimethylphenol]; 3,3′-Diaminobenzidine; 4,4′-methylenebis[2-amino-3,6-dimethylphenol]; 4,4′[2,2,2-trifluoro-1-[3-(trifluoromethyl)phenyl]ethylidene]bis[2-aminophenol]; 4,4′-[1-[4-[1-(3-amino-4-hydroxyphenyl)-1-methylethyl]phenyl]ethylidene]bis[2-aminophenol]; 2,3,5,6-tetramethyl-1,4-phenylenediamine (4MPD); 2,4,6-trimethyl-m-phenylenediamine (3MPD); Acetoguanamine; 4,4′-oxydianiline; 3,4′-oxydianiline; 3,3′,5,5′-tetramethyl-4,4′-diaminodiphenylmethane; 1,3-bis(4-aminophenoxy)benzene; 4,4′-bis(4-amino-2-trifluoromethylphenoxy)biphenyl; 2,2′-bis(trifluoromethyl)benzidine; 2,2-bis(4-(4-aminophenoxy)phenyl)hexafluoropropane; 1,4-bis(4-amino-2-trifluoromethylphenoxy)benzene or combinations thereof. The diamine mixture comprises a 1:1 HAB/4MPD, HAB/4MPD, 1:3 HAB/4MPD, 1:1 APAF/3MPB, and combinations and modifications thereof.

The present invention provides a pervaporation system for dehydrating an organic mixture or separating a liquid mixture comprising at least one organic solvent, water or both having a cell with a membrane comprising polybenzoxazole (PBO), polybenzimidazole (PBI), polybenzothiazoles (PBT), wherein the membrane divides the cell into a first feed side in contact with a liquid mixture to be separated and a second permeate side, wherein the permeate side is opposite to the feed side and is maintained at vacuum or at a lower pressure, wherein the selective layer of the membrane comprises a thermally rearranged aromatic polyimide (API) or aromatic polyamide (APA) precursor with a functional group in an ortho position relative to a nitrogen atom of an imide or the amide ring of the API or APA precursor, wherein the membrane is prepared by the thermal treatment of a polyimide synthesized by the polycondensation of a dianhydride or dianhydride mixture along with a diamine or a diamine mixture; and a magnetic stirrer, an impeller, a stir bar or any other suitable device to agitate a liquid mixture in contact with the feed side; a vacuum pump or any other suitable device to provide vacuum or lower a pressure on the permeate side to vaporize one or more components of the mixture permeating through the membrane; and an optional collection vessel, a cooling chamber, a cooled crystallizer for collecting or condensing a vapor from the permeate side.

The present invention provides a process for separating a liquid phase or a vapor phase mixture having at least two components by contacting the mixture with a first side of a perm-selective membrane, wherein the perm-selective membrane comprises a thermally rearranged polyimide polymer comprising one or more ortho-functional group void spaces formed by thermal rearrangement of a polyimide or polyamide polymer with ortho-functional groups into a thermally rearranged polyimide polymer with one or more ortho-functional group void spaces; permeating selectively the water of the mixture to a permeate side, wherein the permeate side is opposite to the first side and is maintained at vacuum or a lowered pressure; and separating the liquid mixture by recovering the permeated water vapor from the permeate side, wherein the vapor may optionally be cooled to liquid or processed further.

The present invention provides a process for separating a mixture having at least two components by contacting the mixture with a first side of a perm-selective membrane, wherein the perm-selective membrane comprises a thermally rearranged polymer having the structure:

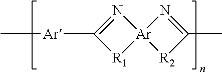

with one or more ortho-positioned functional group voids formed from the rearrangement of the polymer having the structure:

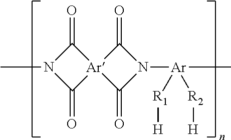

wherein Ar is a first aromatic group having an ortho-positioned functional group R1 and R2 and Ar′ is a second aromatic group; and permeating selectively the water of the mixture to a permeate side, wherein the permeate side is opposite to the first side and is maintained at vacuum or a lowered pressure; and separating the liquid mixture by recovering the permeated water vapor from the permeate side, wherein the vapor may optionally be cooled to liquid or processed further, wherein the permeate is enriched in an amount of at least one of the permeated component, wherein the liquid may be collected as is and the vapor may optionally be cooled to liquid or processed further.

The mixture comprises at least one organic solvent, selected from the group consisting of methanol, ethanol, n-propanol, isopropanol, n-butanol, sec-butanol, tert-butanol, ethylene glycol, cyclohexanol, benzyl alcohol, formic acid, acetic acid, propionic acid, butyric acid, butyl acetate, ethyl acetate, acetone, methyl ethyl ketone, tetrahydrofuran, dioxane, dibutyl amine and aniline. The functional group is an alcohol (—OH), amine (—NH₂) or a thiol (—SH) group.

The selective layer of the perm-selective membrane is a polybenzoxazole (PBO), a polybenzimidazole (PBI), a polybenzothiazole (PBT), a poly(benzoxazole-co-imide), a poly(benzoxazole-co-amide), a poly(benzothiazole-co-imide), a poly(benzothiazole-co-amide), a poly(benzimidazole-co-imide), or a poly(benzimidazole-co-amide) prepared by the thermal treatment of a polyimide synthesized by the polycondensation of a diamine or a diamine mixture along with either a dianhydride or dianhydride mixture or a diacid halide or diacid halide mixture.

The thermal treatment may be carried out at temperatures ranging from 150° C. to 600° C. and more specifically, carried out at a temperature of about 125° C., 150° C., 175° C., 200° C., 225° C., 250° C., 275° C., 300° C., 325° C., 350° C., 375° C., 400° C., 425° C., 450° C. 475° C., 500° C., 525° C., 550° C., 575° C., 600° C., or 625° C. The process may be pervaporation or vapor permeation. The mixture may be an azeotrope. The polymeric membrane may have a selectivity ranging from 1.1 to 10,000 for the vapor permeation process.

The present invention provides a method of separating a vapor mixture comprising ethanol and water by providing a polymeric membrane or a membrane module comprising polybenzoxazole (PBO), polybenzimidazole (PBI), polybenzothiazoles (PBT) or combinations and modifications thereof, wherein the membrane comprises a feed side and a permeate side, wherein the permeate side is opposite to the feed side and is maintained at vacuum or at a lower pressure; contacting the vapor mixture with the feed side of the polymeric membrane or membrane module; permeating selectively the water as water vapor to a permeate side, removing a retentate vapor depleted in an amount of the water vapor and consequently enriched in an amount of the ethanol vapor from the feed side of the membrane or membrane module; separating the permeated water vapor from the permeate side, wherein the vapor may optionally be cooled to liquid or processed further.

The PBO, PBI or the PBT selective layers of the membranes may be prepared by the thermal treatment of a polyimide or polyamide synthesized by the polycondensation of a diamine or a diamine mixture along with either a dianhydride or dianhydride mixture or a diacid halide or diacid halide mixture.

The present invention provides a vapor permeation system for dehydrating an organic vapor mixture or separating a vapor mixture comprising ethanol and water having a cell comprising a perm-selective polymeric membrane, membrane module, membrane assembly, a solid support, microfiltration membrane or combinations, and modifications thereof comprising polybenzoxazole (PBO), polybenzimidazoles (PBI) polybenzothiazoles (PBT), wherein the membrane divides the cell into a first feed side in contact with the vapor mixture to be separated and a second permeate side, wherein the permeate side is opposite to the feed side and is maintained at vacuum or at a lower pressure, wherein the selective layer of the membrane comprises a thermally rearranged aromatic polyimide (API) or aromatic polyamide (APA) precursor with a functional group in an ortho position relative to a nitrogen atom of an imide or the amide ring of the API or APA precursor; and a vacuum pump or any other suitable device to provide vacuum or lower a pressure on the permeate side of the membrane.

The system further includes a magnetic stirrer, an impeller, a stir bar or any other suitable device to agitate the vapor in contact with the feed side; and an optional collection vessel, a cooling chamber, a cooled crystallizer for collecting or condensing a vapor from the permeate side.

The mixture may include at least one organic component, selected from the group consisting of methanol, ethanol, n-propanol, isopropanol, n-butanol, sec-butanol, tert-butanol, ethylene glycol, cyclohexanol, benzyl alcohol, formic acid, acetic acid, propionic acid, butyric acid, butyl acetate, ethyl acetate, acetone, methyl ethyl ketone, tetrahydrofuran, dioxane, dibutyl amine and aniline.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

### REFERENCES

U.S. Pat. No. 7,810,652: Method to Improve the Selectivity of Polybenzoxazole Membranes.
U.S. Patent Application No. 20100133186: High Performance Cross-Linked Polybenzoxazole and Polybenzothiazole Polymer Membranes.
WIPO Patent Application No. WO/2009/107889: Polyimide-co-Polybenzoxazole Copolymer, Preparation Method Thereof, and Gas Separation Membrane Comprising the Same.

(1) Sissine, F. Energy Independence and Security Act of 2007: a summary of major provisions; Library of Congress: Washington, 2007.
(2) Côtè, P.; Noël, G.; Moore, S. Desalination. 2010, 250, 1060-1066.
(3) Huang, Y.; Ly, J.; Nguyen, D.; Baker, R. W. Industrial & Engineering Chemistry Research. 2010.
(4) Azeotropic Data—III; Horsley, L. H.; American Chemical Society, 1973.
(5) Vane, L. M.; Alvarez, F. R.; Huang, Y.; Baker, R. W. Journal of Chemical Technology & Biotechnology. 2009, 85, 502-511.
(6) Shao, P.; Huang, R. Y. Journal of Membrane Science. 2007, 287, 162-179.
(7) Huang, Y.; Baker, R. W.; Vane, L. M. Industrial & Engineering Chemistry Research. 2010, 49, 3760-3768.
(8) Chapman, P. D.; Oliveira, T.; Livingston, A. G.; Li, K. Journal of Membrane Science. 2008, 318, 5-37.
(9) Hsiao, S.; Chen, Y. High Performance Polymers. 2000, 12, 515-524.
(10) Park, H. B.; Jung, C. H.; Lee, Y. M.; Hill, A. J.; Pas, S. J.; Mudie, S. T.; Van Wagner, E.; Freeman, B. D.; Cookson, D. J. Science. 2007, 318, 254-8.
(11) Fan, I. V.; Kratzner, D.; Glass, T. E.; Dunson, D.; Ji, Q.; McGrath, J. E. Journal of Polymer Science A: Polymer Chemistry. 2000, 38, 2840-2854.
(12) Likhatchev, D.; Gutierrez-Wing, C.; Kardash, I.; Vera-Graziano, R. Journal of Applied Polymer Science. 1996, 59, 725-735.
(13) Muñoz, D. M.; de la Campa, J. G.; de Abajo, J.; Lozano, A. E. Macromolecules. 2007, 40, 8225-8232.
(14) Lee, H. R.; Yu, T. A.; Lee, Y. D. Macromolecules. 1990, 23, 502-509.
(15) Nakagawa, K.; Kusuki, Y.; Ninomiya, K. Proceedings of the Fourth International Congress on Pervaporation Processes in the Chemical Industry. 1989, 250-260.
(16) Gmehling, J.; Onken, U.; Arlt, W. Vapor-Liquid Equilibrium Data Collection; Dechema: Frankfurt, 1977.
(17) Perry's Chemical Engineer's Handbook; Perry, R. H.; Green, D. W.; 7th Editio.; McGraw-Hill Professional: New York, 1997.
(18) Dymond, J. H.; Marsh, K. N.; Wilhoit, R. C.; Wong, K. C. The Virial Coefficients of Pure Gases and Mixtures; Springer: Darmstadt, 2001.
(19) Ribeiro Jr., C. P.; Borges, C. P. Brazilian Journal of Chemical Engineering. 2004, 21, 629-640
(20) Ohya, H.; Kudryavtsev, V. V.; Semenova, S. I. In Polyimide membranes: applications, fabrications, and properties; 1996.
(21) Lin, H; Freeman, B. D. Journal of Membrane Science, 2004, 239, 105-117.
(22) Baker, R.; Membrane Technology and Applications, John Wiley & Sons Ltd.; 2008, PP 290-291, 318-321.
(23) Han, S. H., Misdan, N., Kim, S., Doherty, C. M., Hill, A. J., and Lee, Y. M., Macromolecules, 2010. 43, 7657-7667.

What is claimed is:

1. A membrane module for dehydrating an organic mixture or separating a liquid mixture comprising:
a perm-selective polymeric membrane module comprising polybenzoxazole (PBO), polybenzimidazole (PBI), or polybenzothiazoles (PBT), wherein the perm-selective polymeric membrane module comprises
a selective layer of the perm-selective polymeric membrane module comprising a thermally rearranged aromatic polyimide (API) or aromatic polyamide (APA) precursor with a functional group in an ortho position relative to a nitrogen atom of an imide or the amide ring of the API or APA precursor;
a membrane feed side of the perm-selective polymeric membrane module adapted to contact a liquid mixture to be separated; and
a membrane permeate side opposite to the membrane feed side that is adapted to be maintained at a lower pressure.

2. The membrane module of claim 1, wherein the PBO, PBI or the PBT comprise a thermally treated polycondensation polyimide or polyamide comprising a dianhydride or dianhydride mixture along with a diamine or a diamine mixture or a diacid halide or a diacid halide mixture along with a diamine or a diamine mixture,
wherein the dianhydride is 3,3′,4,4′-Benzophenone tetracarboxylic dianhydride; Pyromellitic dianhydride; 3,3′,4,4′-biphenyl tetracarboxylic dianhydride; 2,2′-bis-(3,4-dicarboxyphenyl)hexafluoropropane dianhydride (6FDA); 4,4′-oxydiphthalic anhydride; 3,3′,4,4′-diphenylsulfone tetracarboxylic dianhydride; 4,4′-bisphenol A dianhydride; Hydroquinone diphthalic anhydride; 5-(2,5′-dioxotetrahydrol)-3-methyl-3-cyclohexene-1,2-dicarboxylic anhydride; Ethylene glycol bis(trimellitic anhydride); 2,3,3′,4′-biphenyltetracarboxylic acid dianhydride; Naphthalene-1,4,5,8-tetracarboxylicdianhydride; 3,3′4,4′-diphenylsulfonetetracarboxylic dianhydride; 3,4,9,10-perylenetetracarboxylic dianhydride; and combinations thereof;
wherein the diacid halide or a diacid halide mixture is [1,1′-Biphenyl]-3,3′-dicarbonyl dichloride, [1,1′-Biphenyl]-4,4′-dicarbonyl dichloride, [1,1′-Biphenyl]-3,4′-dicarbonyl dichloride, 4,4′-(1-methylethylidene)bis-benzoyl chloride, 4,4′-[2,2,2-trifluoro-1-(trifluoromethyl)ethylidene]bis-benzoyl chloride, 9,9-dioctyl-9H-Fluorene-2,7-dicarbonyl dichloride, 9,9-dimethyl-9H-Fluorene-2,7-dicarbonyl dichloride, 1,4-Benzenedicarbonyl dichloride, 1,3-Benzenedicarbonyl dichloride, 4,4′-[2,2,2-trifluoro-[3-(trifluoromethyl)phenyl]ethylidene]bis-benzoyl chloride, 4,4′-oxybis-benzoyl chloride, 4,4′-carbonylbis-benzoyl chloride or combinations thereof;
wherein the diamines are selected from the group consisting 2,3,5,6-tetramethyl-1,4-phenylenediamine (4MPD), and 2,4,6-trimethyl-m-phenylenediamine (3MPD); 3,3′-hydroxy-4,4′-diamino-biphenyl (HAB); 2,2-bis(3-amino-4-hydroxyphenyl)-hexafluoropropane (APAF); 2,5-diamino-1,4-Benzenediol; 2,5-diamino-1,4-Benzenedithiol (DABT); 4,4′-(1-methylethylidene)bis[2,6-diaminophenol]; 2,2-Bis(3-amino-4-hydroxyphenyl)propane; 3,3′-Diamino-4,4′-dihydroxydiphenylmethane; 4,4′-ethylidenebis[2-amino-3,6-dimethylphenol]; 3,3′-Diaminobenzidine; 4,4′-methylenebis[2-amino-3,6-dimethylphenol]; 4,4′-[2,2,2-trifluoro-1-[3-(trifluoromethyl)phenyl]ethylidene]bis[2-aminophenol]; 4,4′-[1-[4-[1-(3-amino-4-hydroxyphenyl)-1-methylethyl]phenyl]ethylidene]bis[2-aminophenol]; 2,3,5,6-tetramethyl-1,4-phenylenediamine (4MPD); 2,4,6-trimethyl-m-phenylenediamine (3MPD); Acetoguanamine; 4,4′-oxydianiline; 3,4′-oxydianiline; 3,3′,5,5′-tetramethyl-4,4′-diaminodiphenylmethane; 1,3-bis(4-aminophenoxy)benzene; 4,4′-bis(4-amino-2-trifluoromethylphenoxy)biphenyl; 2,2′-bis(trifluoromethyl)benzidine; 2,2-bis(4-(4-aminophenoxy)phenyl)hexafluoropropane; 1,4-bis(4-amino-2-trifluoromethylphenoxy)benzene or combinations thereof; and
wherein the diamine mixture comprises a 1:1 HAB/4MPD, HAB/4MPD, 1:3 HAB/4MPD, 1:1 APAF/3MPB, and combinations and modifications thereof.

3. A pervaporation system for dehydrating an organic mixture or separating a liquid mixture comprising at least one organic solvent, water or both comprising:
a cell comprising:
a membrane comprising polybenzoxazole (PBO), polybenzimidazole (PBI), polybenzothiazoles (PBT), wherein the membrane divides the cell into a first feed side in contact with a liquid mixture to be separated and a second permeate side, wherein the permeate side is opposite to the feed side and is maintained at vacuum or at a lower pressure, wherein the selective layer of the membrane comprises a thermally rearranged aromatic polyimide (API) or aromatic polyamide (APA) precursor with a functional group in an ortho position relative to a nitrogen atom of an imide or the amide ring of the API or APA precursor, wherein the membrane is prepared by the thermal treatment of a polyimide synthesized by the polycondensation of a dianhydride or dianhydride mixture along with a diamine or a diamine mixture; and
a magnetic stirrer, an impeller, a stir bar or any other suitable device to agitate a liquid mixture in contact with the feed side;
a vacuum pump or any other suitable device to provide vacuum or lower a pressure on the permeate side to vaporize one or more components of the mixture permeating through the membrane; and
an optional collection vessel, a cooling chamber, a cooled crystallizer for collecting or condensing a vapor from the permeate side.

4. A process for separating a liquid phase or a vapor phase mixture having at least two components comprising the steps of:
contacting the mixture with a first side of a perm-selective membrane, wherein the perm-selective membrane comprises
a thermally rearranged polyimide polymer comprising one or more ortho-functional group void spaces formed by thermal rearrangement of a polyimide or polyamide polymer with ortho-functional groups into a thermally rearranged polyimide polymer with one or more ortho-functional group void spaces;
permeating selectively the water of the mixture to a permeate side, wherein the permeate side is opposite to the first side and is maintained at vacuum or a lowered pressure; and
separating the liquid mixture by recovering the permeated water vapor from the permeate side, wherein the vapor may optionally be cooled to liquid or processed further.

5. A process for separating a mixture having at least two components comprising the steps of:
contacting the mixture with a first side of a perm-selective membrane, wherein the perm-selective membrane comprises a thermally rearranged polymer having the structure: 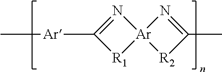
with one or more ortho-positioned functional group voids formed from the rearrangement of the polymer having the structure: 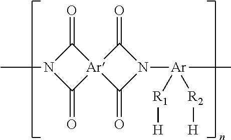
wherein Ar is a first aromatic group having an ortho-positioned functional group R1 and R2 and Ar′ is a second aromatic group; and
permeating selectively the water of the mixture to a permeate side, wherein the permeate side is opposite to the first side and is maintained at vacuum or a lowered pressure; and
separating the liquid mixture by recovering the permeated water vapor from the permeate side, wherein the vapor may optionally be cooled to liquid or processed further, wherein the permeate is enriched in an amount of at least one of the permeated component, wherein the liquid may be collected as is and the vapor may optionally be cooled to liquid or processed further.

6. The process of claim 5, wherein the mixture comprises at least one organic solvent, selected from the group consisting of methanol, ethanol, n-propanol, isopropanol, n-butanol, sec-butanol, tert-butanol, ethylene glycol, cyclohexanol, benzyl alcohol, formic acid, acetic acid, propionic acid, butyric acid, butyl acetate, ethyl acetate, acetone, methyl ethyl ketone, tetrahydrofuran, dioxane, dibutyl amine and aniline.

7. The process of claim 5, wherein the functional group is an alcohol (—OH), amine (—NH₂) or a thiol (—SH) group.

8. The process of claim 5, wherein the selective layer of the perm-selective membrane is a polybenzoxazole (PBO), a polybenzimidazole (PBI), a polybenzothiazole (PBT), a poly(benzoxazole-co-imide), a poly(benzoxazole-co-amide), a poly(benzothiazole-co-imide), a poly(benzothiazole-co-amide), a poly(benzimidazole-co-imide), or a poly(benzimidazole-co-amide) prepared by the thermal treatment of a polyimide synthesized by the polycondensation of a diamine or a diamine mixture along with either a dianhydride or dianhydride mixture or a diacid halide or diacid halide mixture.

9. The process of claim 5, wherein the thermal treatment is carried out at a temperature of about 125° C., 150° C., 175° C., 200° C., 225° C., 250° C., 275° C., 300° C., 325° C., 350° C., 375° C., 400° C., 425° C., 450° C. 475° C., 500° C., 525° C., 550° C., 575° C., 600° C., or 625° C.

10. The process of claim 5, wherein the process is pervaporation or vapor permeation.

11. The process of claim 5, wherein the polymeric membrane has a selectivity ranging from 1.1 to 10,000 for the vapor permeation process.

12. The method of claim 5, wherein the mixture has an azeotrope.

13. A method of separating a vapor mixture of ethanol and water comprising the steps of:
providing a polymeric membrane or a membrane module comprising polybenzoxazole (PBO), polybenzimidazole (PBI), polybenzothiazoles (PBT) or combinations and modifications thereof, wherein the membrane comprises a feed side and a permeate side, wherein the permeate side is opposite to the feed side and is maintained at vacuum or at a lower pressure;
contacting the vapor mixture with the feed side of the polymeric membrane or membrane module;
permeating selectively the water as water vapor to a permeate side;
removing a retentate vapor depleted in an amount of the water vapor and consequently enriched in an amount of the ethanol vapor from the feed side of the membrane or membrane module; and
separating the permeated water vapor from the permeate side, wherein the vapor may optionally be cooled to liquid or processed further.

14. The method of claim 13, wherein the PBO, PBI or the PBT selective layers of the membranes are prepared by the thermal treatment of a polyimide or polyamide synthesized by the polycondensation of a diamine or a diamine mixture along with either a dianhydride or dianhydride mixture or a diacid halide or diacid halide mixture.

15. The method of claim 13, wherein the dianhydride is 3,3′,4,4′-Benzophenone tetracarboxylic dianhydride; Pyromellitic dianhydride; 3,3′,4,4′-biphenyl tetracarboxylic dianhydride; 2,2′-bis-(3,4-dicarboxyphenyl)hexafluoropropane dianhydride (6FDA); 4,4′-oxydiphthalic anhydride; 3,3′,4,4′-diphenylsulfone tetracarboxylic dianhydride; 4,4′-bisphenol A dianhydride; Hydroquinone diphthalic anhydride; 5-(2,5′-dioxotetrahydrol)-3-methyl-3-cyclohexene-1,2-dicarboxylic anhydride; Ethylene glycol bis(trimellitic anhydride); 2,3,3′,4′-biphenyltetracarboxylic acid dianhydride; Naphthalene-1,4,5,8-tetracarboxylicdianhydride; 3,3′4,4′-diphenylsulfonetetracarboxylic dianhydride; 3,4,9,10-perylenetetracarboxylic dianhydride; and combinations thereof;
wherein the diacid halide or a diacid halide mixture is [1,1′-Biphenyl]-3,3′-dicarbonyl dichloride, [1,1′-Biphenyl]-4,4′-dicarbonyl dichloride, [1,1′-Biphenyl]-3,4′-dicarbonyl dichloride, 4,4′-(1-methylethylidene)bis-benzoyl chloride, 4,4′-[2,2,2-trifluoro-1-(trifluoromethyl)ethylidene]bis-benzoyl chloride, 9,9-dioctyl-9H-Fluorene-2,7-dicarbonyl dichloride, 9,9-dimethyl-9H-Fluorene-2,7-dicarbonyl dichloride, 1,4-Benzenedicarbonyl dichloride, 1,3-Benzenedicarbonyl dichloride, 4,4′-[2,2,2-trifluoro-[3-(trifluoromethyl)phenyl]ethylidene]bis-benzoyl chloride, 4,4′-oxybis-benzoyl chloride, 4,4′-carbonylbis-benzoyl chloride or combinations thereof;
wherein the diamines are selected from the group consisting 2,3,5,6-tetramethyl-1,4-phenylenediamine (4MPD), and 2,4,6-trimethyl-m-phenylenediamine (3MPD); 3,3′-hydroxy-4,4′-diamino-biphenyl (HAB); 2,2-bis(3-amino-4-hydroxyphenyl)-hexafluoropropane (APAF); 2,5-diamino-1,4-Benzenediol; 2,5-diamino-1,4-Benzenedithiol (DABT); 4,4′-(1-methylethylidene)bis[2,6-diaminophenol]; 2,2-Bis(3-amino-4-hydroxyphenyl)propane; 3,3′-Diamino-4,4′-dihydroxydiphenylmethane; 4,4′-ethylidenebis[2-amino-3,6-dimethylphenol]; 3,3′-Diaminobenzidine; 4,4′-methylenebis[2-amino-3,6-dimethylphenol]; 4,4′-[2,2,2-trifluoro-[3-(trifluoromethyl)phenyl]ethylidene]bis[2-aminophenol]; 4,4′-[1-[4-[1-(3-amino-4-hydroxyphenyl)-1-methylethyl]phenyl]ethylidene]bis[2-aminophenol]; 2,3,5,6-tetramethyl-1,4-phenylenediamine (4MPD); 2,4,6-trimethyl-m-phenylenediamine (3MPD); Acetoguanamine; 4,4′-oxydianiline; 3,4′-oxydianiline; 3,3′,5,5′-tetramethyl-4,4′-diaminodiphenylmethane; 1,3-bis(4-aminophenoxy)benzene; 4,4′-bis(4-amino-2-trifluoromethylphenoxy)biphenyl; 2,2′-bis(trifluoromethyl)benzidine; 2,2-bis(4-(4-aminophenoxy)phenyl)hexafluoropropane; 1,4-bis(4-amino-2-trifluoromethylphenoxy)benzene or combinations thereof; and
wherein the diamine mixture comprises a 1:1 HAB/4MPD, HAB/4MPD, 1:3 HAB/4MPD, 1:1 APAF/3MPB, and combinations and modifications thereof.

16. The method of claim 15, wherein the polymeric membrane has a selectivity ranging from 1.1 to 10,000 for the vapor permeation process.

17. A vapor permeation system for dehydrating an organic vapor mixture or separating a vapor mixture comprising ethanol and water comprising:
a cell comprising a perm-selective polymeric membrane, membrane module, membrane assembly, a solid support, microfiltration membrane or combinations, and modifications thereof comprising polybenzoxazole (PBO), polybenzimidazoles (PBI) polybenzothiazoles (PBT), wherein the membrane divides the cell into a first feed side in contact with the vapor mixture to be separated and a second permeate side, wherein the permeate side is opposite to the feed side and is maintained at vacuum or at a lower pressure, wherein the selective layer of the membrane comprises a thermally rearranged aromatic polyimide (API) or aromatic polyamide (APA) precursor with a functional group in an ortho position relative to a nitrogen atom of an imide or the amide ring of the API or APA precursor; and
a vacuum pump or any other suitable device to provide vacuum or lower a pressure on the permeate side of the membrane.

18. The system of claim 17, wherein the system further comprises:
a magnetic stirrer, an impeller, a stir bar or any other suitable device to agitate the vapor in contact with the feed side; and
an optional collection vessel, a cooling chamber, a cooled crystallizer for collecting or condensing a vapor from the permeate side.

19. The system of claim 17, wherein the mixture comprises at least one organic component, selected from the group consisting of methanol, ethanol, n-propanol, isopropanol, n-butanol, sec-butanol, tert-butanol, ethylene glycol, cyclohexanol, benzyl alcohol, formic acid, acetic acid, propionic acid, butyric acid, butyl acetate, ethyl acetate, acetone, methyl ethyl ketone, tetrahydrofuran, dioxane, dibutyl amine and aniline.

20. The system of claim 17, wherein the mixture has an azeotrope.

21. The system of claim 17, wherein the PBO, PBI or PBT membranes are prepared by the thermal treatment of a polyimide synthesized by the polycondensation of a dianhydride or dianhydride mixture along with a diamine or a diamine mixture or of a diacid halide or a diacid halide mixture along with a diamine or a diamine mixture.

22. The system of claim 17, wherein the thermal treatment is carried out at temperatures ranging from 150° C. to 600° C.
